(19) United States
(12) Patent Application Publication
(10) Pub. No.: US 2004/0252030 A1
(43) Pub. Date: Dec. 16, 2004

(54) Object locating system including addressable remote tags

(76) Inventors: Bradley G. Trimble, Milwaukee, WI (US); Lance A. Ehrke, Brookfield, WI (US); Paul A. Wechter, Milwaukee, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/826,541

(22) Filed: Apr. 16, 2004

Related U.S. Application Data
(63) Continuation-in-part of application No. 10/279,405, filed on Oct. 24, 2002, now abandoned.
Application No. 10/279,405 is a continuation of application No. 09/679,841, filed on Oct. 5, 2000, now abandoned.
(60) Provisional application No. 60/157,955, filed on Oct. 6, 1999.
(60) Provisional application No. 60/225,208, filed on Aug. 14, 2000.

(51) Int. Cl. G08B 13/14; G08B 5/22

(52) U.S. Cl. 340/825.36

(57) ABSTRACT

An object locating system includes a transmitter unit for activating a plurality of electronic tags to assist in locating keys, remote control devices, cordless phones, eyeglasses, articles of clothing, etc. to which the tags have been attached. The tags are self-contained, battery powered devices that signal their presence, when activated, by an audible and/or visual indication to get the attention of the user. In one embodiment for locating objects in a user's residence, a telephone interface unit responds to DTMF signals transmitted to a multi-frequency receiver over a communication link from a telephone at a location remote from or in the user's residence to produce an RF activating signal for activating a tag associated with an object to be located. The system can be used for identifying baggage, luggage, sporting equipment, and packages being dispensed from an airport baggage carousel.

### CROSS REFERENCE TO RELATED APPLICATIONS

This application is a continuation-in-part of application Ser. No. 10/279,405, which is a continuation of application Ser. No. 09/679,841, now abandoned, which claims benefit of Provisional Patent Application No. 60/157,955 filed on Oct. 6, 1999 and Provisional Patent Application No. 60/225,208, which was filed on Aug. 14, 2000.

### BACKGROUND OF THE INVENTION

This invention relates to a system and apparatus for locating or identifying objects, and more particularly, to a system and apparatus including selectively actuated radio frequency receivers carried by objects to be located and which are responsive to radio frequency signals transmitted by a transmitter unit for providing an audible and/or visual indication to aid a person in locating or identifying an object.

Various methods have been proposed for locating lost or misplaced items such as keys, eyeglasses, wallets or purses, remote control devices, and generally items which are hand-carried by a person and which are prone to misplacement. The items can be concealed by furniture and other objects or the items can be simply placed in an unusual location where the owner subsequently has difficulty in locating them. In known item location systems, signal receivers are coupled to the items, which are prone to misplacement, each signal receiver being responsive to a unique activation signal. A hand-held transmitter is used to control selective activation of the signal receivers to cause the signal receiver associated with a lost or misplaced item to provide an audible response to indicate the location of the item.

Typically, known item location systems have been used for locating lost or misplaced items within a personal residence, such as a house or an apartment. In such systems, a radio frequency link is established between a RF transmitter carried by a person seeking an item and a RF receiver attached to the item being sought. Generally, such a system is used by one person to locate only about four to six items. No provision is made for simultaneously locating a plurality of objects for several people.

A further consideration is that elderly or infirm persons may have difficulty in using the transmitter to find an item, such as eyeglasses or keys. Consequently, such person may have to seek the assistance of another person, such as a neighbor, a relative or a friend. Typically, the person seeking the item would either have to leave their residence seeking help from a neighbor, a relative or a friend, for example, or would have to telephone the neighbor, the relative or the friend to seek help and direction in locating the lost or misplaced item. Frequently, this might require that the person whose assistance was requested would have to physically go to the residence of the person seeking the eyeglasses or keys to help find the lost items.

Another consideration is that the remote receivers that are used in a known item location systems are identical in appearance and, as such, do not uniquely identify an item with which it is associated. Although such receiver, when activated, produces an audible signal, such signal is not always helpful in identifying an item in crowded or noisy locations.

### SUMMARY OF THE INVENTION

The present invention provides a system and apparatus for locating and/or identifying objects. In one embodiment, the object locating system provided by the present invention includes at least one transmitter unit which is used to activate a plurality of receivers, such as electronic tags. The electronic tags are remotely activated devices used to assist in locating an object to which the tags have been attached. The objects to be located can be inanimate objects, such as a set of keys, a remote control device, a cordless phone, a pair of glasses, an article of clothing, a wallet/purse, a hand tool, and generally any item which can be hand-carried by a person and is prone to misplacement. Moreover, the objects to be located can be animate objects, such as a pet or other animal. In one embodiment, the electronic tags are self-contained, battery powered devices that signal their presence when activated. When activated, the electronic tags produce an audible and/or visual indication for getting the attention of the user. In one embodiment, a telephone interface unit responds to frequency signals transmitted over a communication link for producing RF activating signals for activating an electronic tag associated with an object to be located.

Further in accordance with the invention, another embodiment provides system and apparatus for identifying baggage, such as luggage, sporting equipment, packages, and the like, which have been checked during travel and which are being distributed or dispensed by airline personnel, and in particular, from a carousel in an airport, for example.

### BRIEF DESCRIPTION OF THE DRAWINGS

The drawings illustrate the best mode presently contemplated of carrying out the invention.

In the drawings:

FIG. 1 is a simplified representation of an object locating system including a transmitter unit and a plurality of electronic tags provided by the invention;

FIG. 1A is a simplified representation of an object locating system provided by the invention and in which the electronic tags can be activated from a remote location;

FIG. 1B is a simplified representation of an object locating system provided by the invention and including a master transmitter unit;

FIG. 2 is a perspective view of a transmitter unit of the object locating system provided by the invention;

FIG. 3 is a plan view of the transmitter unit of FIG. 2;

FIG. 4 is a fragmentary vertical section view taken along the line 4-4 of FIG. 3;

FIG. 5 is a fragmentary vertical section view taken along the line 5-5 of FIG. 3;

FIG. 6 is a plan view of a master transmitter unit provided by the invention;

FIG. 7 is a plan view of another embodiment of the transmitter unit shown in FIG. 1;

FIG. 8 is a plan view of an electronic tag of the object locating system of the invention;

FIG. 9 is a side view of an electronic tag of FIG. 8;

FIG. 10 is a block diagram of the transmitter unit of FIG. 2;

FIG. 11 is a block diagram of the electronic tag of FIG. 8;

FIG. 12A is illustrates the packet protocol for transmitting from the transmitter unit to the electronic tags;

FIG. 12B is a timing chart illustrating the drive pulses for the audible alarm generating device of the electronic tags;

FIG. 12C is a timing chart illustrating the drive pulses for the visual indicator of the electronic tags;

FIG. 13 is a perspective view of a telephone interface and transmitter unit provided by the invention;

FIG. 14 is a block diagram of the telephone interface and transmitter unit of FIG. 13;

FIG. 15 is a process flow chart for the microprocessor of the telephone interface and transmitter unit of FIGS. 13 and 14;

FIG. 16 is an isometric view of a luggage locator tag provided by the present invention and shown secured to a handle of a piece of luggage;

FIG. 17 is an isometric view of a transmitter unit for activating the luggage locator tag of FIG. 16;

FIG. 18 illustrates a luggage locator tag built into a handle of a piece of luggage;

FIG. 19 is a perspective view of a piece of luggage which has a luggage locator tags built into each side of the luggage;

FIG. 20 is a side view of a piece of luggage which includes a further embodiment for a luggage locator tag built into the luggage;

FIG. 21 is an enlarged end view of the luggage locator tag of FIG. 16 and showing the lens;

FIG. 22 is an enlarged view of a luggage locator tag, which includes a case of a transparent material;

FIG. 23 is a plan view of a key fob for a vehicle for providing remote keyless entry, and which incorporates components of a locator tag in accordance with the present invention;

FIG. 24 is a plan view of the key fob of FIG. 23, partially cut away to show components of a locator tag located within the key fob;

FIG. 25 is a plan view of a master transmitter unit for activating the locator components of the key fob of FIG. 23;

FIG. 26 is an isometric view of a portable tool incorporating a locator tag in accordance with the present invention;

FIG. 27 is a plan view of an adapter for use with a portable tool that includes a locator tag and light source;

FIG. 28 is a plan view similar to FIG. 27 illustrating the position of the adapter between the portable tool and battery pack;

FIG. 29 is a view showing one embodiment for applying an electronic tag to a medication container;

FIG. 30 is a view showing a further embodiment for securing an electronic tag to a medication container;

FIG. 31 is a view showing an electronic tag integrated into a cap of a medication container;

FIG. 32 is a view showing a container including an electronic tag and adapted to receive a medication container;

FIG. 33 is a top plan view of an electronic tag including an LED illumination source;

FIG. 34 is a side view illustrating the electronic tag including an activation button for the LED light source;

FIG. 35 is a block diagram of the electronic tag of FIG. 33;

FIG. 36 is a side view of a key with an electronic locator circuit molded into the head of the key;

FIG. 37 is an enlarged side view of the key of FIG. 36, with the head portion of the key partially sectioned to show the electronic circuits contained therein; and

FIG. 38 is a view similar to that of FIG. 37 of a key in which the head portion is produced using a two-step molding process.

### DETAILED DESCRIPTION OF PREFERRED EMBODIMENTS

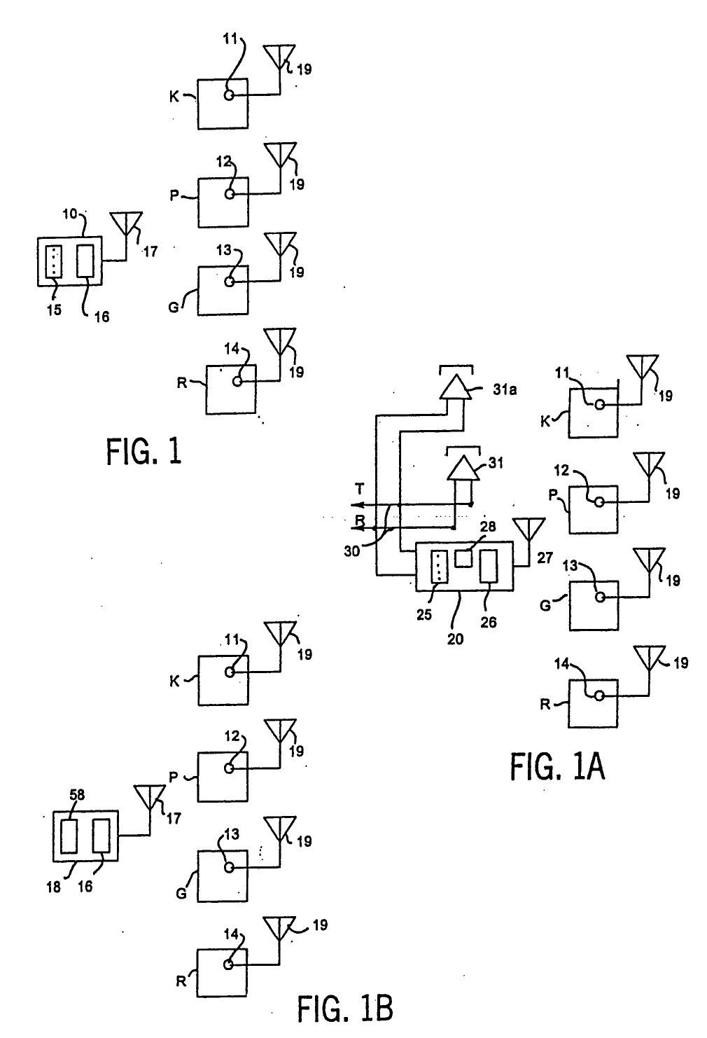

Referring to the FIG. 1 of the drawings, in one embodiment, the object locating system provided by the present invention includes at least one transmitter unit 10 which is used to activate one or more electronic tags, such as electronic tags 11-14. While the exemplary embodiment of the object locating system is described as including only four electronic tags, the object locating system can include four or more electronic tags or less than four electronic tags, depending upon the particular application.

The electronic tags 11-14 are remotely activated devices used to assist in locating an object to which the tags have been attached. The objects K, P, G and R to be located can be inanimate objects, such as a set of keys, a wallet/purse, a pair of eyeglasses, a cane, an umbrella, a book, a remote control device for a garage door, a television set, a DVD player, a CD player, a VHS player, a cordless phone, an article of clothing, a container for medication, a portable tool, and generally any item which can be hand-carried by a person and is prone to misplacement or that a user may want to be able to locate quickly. Moreover, the objects to be located can be animate objects, such as a pet or other animal. As described more fully below, such objects can include one or more packages, such as but not limited to items of luggage.

The electronic tags 11-14 are self-contained, battery powered devices that signal their presence when activated. When activated, the electronic tags produce an audible and/or visual indication for getting the attention of the user. In one embodiment, the electronic tags 11-14 produce both an audible signal and a visual indication when activated. The audible signal can be a sequence of tones or can be produced by a sound sampler device.

The object locating system employs radio frequency (RF) signaling for locating lost or misplaced objects. The transmitter unit 10 includes an RF signal transmitter 16 that transmits a plurality of coded RF signals each of which is detectable by a different one of the electronic tags 11-14. The coded RF signals are radiated by an antenna 17 of the transmitter unit 10 and are picked up by an antenna 19 of the electronic tags 11-14. In one embodiment, the electronic tags are configured to respond to a different one of four or more system carrier signal modulation codes carried on a common frequency signal. A fully configured system can include four or more uniquely programmed electronic tags. The transmitter unit includes a selecting apparatus 15 for selecting the one of the four or more carrier signal modulation codes to be transmitted to activate the electronic tag associated with an object to be located. The transmitter unit 10 can be activated manually using the selecting apparatus 15 shown in FIG. 1, remotely using signals transmitted over a communication link as will be described with reference to FIG. 1A, and/or both manually and remotely. While in the exemplary embodiment, the object locating system includes only four electronic tags 11-14, it is apparent that the object locating system can include more than four electronic tags with appropriate modification of the selecting apparatus 15 and the RF transmitter 16 of the transmitter unit to enable the transmitter unit 10 to produce additional coded RF signals.

Referring to FIG. 1A, the electronic tags 11-14 can be activated from a remote location using activating signals transmitted over a communication link to the transmitter unit 10. Preferably, at least a portion of the communication link includes a standard telephone link, but other portions of the communication link can include wireless telephones, cell telephones, a personal computer, a personal digital assistant, Internet connections and dedicated lines, for example.

In one embodiment, the communication link is a standard telephone line 30 and the object locating system can include a telephone interface and transmitter unit 20. The telephone interface and transmitter unit 20, hereinafter referred to as the telephone interface unit 20, is adapted to be coupled to the telephone line 30 at the location of the telephone 31, for example, in the user's residence. The telephone interface unit 20 includes a selecting apparatus 25 and an RF signal transmitter 26 which correspond to the selecting apparatus 15 and RF signal transmitter 16 of the transmitter unit 10. In addition, the telephone interface unit 20 includes a frequency signal receiver 28 which responds to frequency signals transmitted over the telephone line 30 to the telephone interface unit 20 for causing the RF signal transmitter 25 to transmit coded RF activating signals for activating the electronic tag associated with an object to be located. In one embodiment, the conventional dual tone, multi-frequency signals of the telephone system are used in causing remote activation of electronic tags using the telephone interface unit 20.

Briefly, a person looking for an item, such as a pair of eyeglasses, can telephone a neighbor, a relative or a friend and tell that person that assistance is needed in locating the eyeglasses. This neighbor, relative or friend, who has been previously been made aware of how to respond to such call for assistance, would depress preselected pushbuttons on their telephone. This causes a sequence of known, conventional, dual tone, multi-frequency signals to be transmitted via the telephone line 30 to the telephone interface unit 20. The receiver 28 of the telephone interface unit 20 responds to the dual tone, multi-frequency signals and causes the RF transmitter 26 to transmit the appropriate coded RF activating signal which is radiated by antenna 27 throughout the area. The electronic tag that is configured to respond to the transmitted coding responds to the activating signal and provides an audible signal and a visible indication for indicating the location of the eyeglasses. The activation process can be initiated by a person at a remote location, allowing that person to anticipate a need, or to remind the called party to take a medicine, for example, by causing activation of an electronic tag secured to or otherwise associated with a medicine bottle. Moreover, although the transmitter unit 10 is shown in FIG. 1 to be a portable hand held unit, the transmitter unit 10 can be adapted to be carried on a chain, allowing the transmitter unit 10 to be worn around the neck of the user.

Referring to FIG. 1B, the object locating system includes a master transmitter unit 18, which can be used to activate a plurality of electronic tags 11-14. The master transmitter unit has particular application in a nursing home or other type of assisted care facility, for enabling a person in charge to locate misplaced or lost items belonging to one or more residents of the facility.

The object locating system can include a transmitter unit, such as in the systems shown in FIGS. 1 and 1B, or can include a telephone interface unit such as in the system shown in FIG. 1A, or can include a telephone interface unit in addition to a transmitter unit. Moreover, the system can include more than one transmitter unit and/or telephone interface units depending upon the particular application. For example, when used in a private dwelling, the object locating system can include both a transmitter unit and a telephone interface unit. When used in a retirement home, a nursing home, or some other type of assisted care facility, the object locating system can include a plurality of transmitter units.

Transmitter Unit

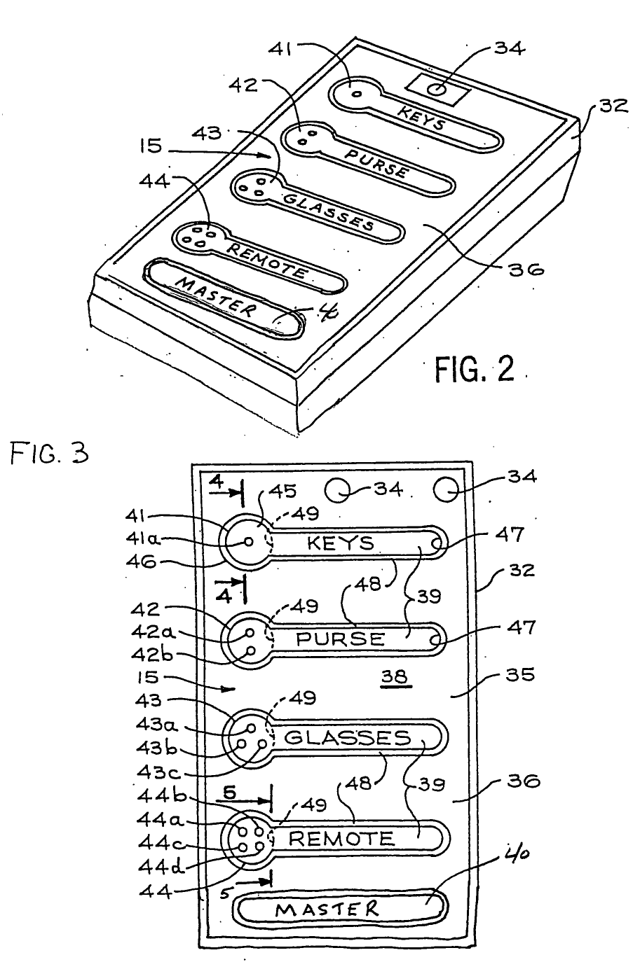

Referring to FIGS. 2, 3 and 10, the transmitter unit 10 includes the selecting apparatus 15, a microprocessor 33, the RF signal transmitter 16, an indicator 34, a case 32 and a power supply circuit 35. The transmitter unit 10 is a self-contained, portable, hand-held, device. The case 32 encloses the components of the transmitter unit 10. In one embodiment, the case 32 is made of a durable plastic.

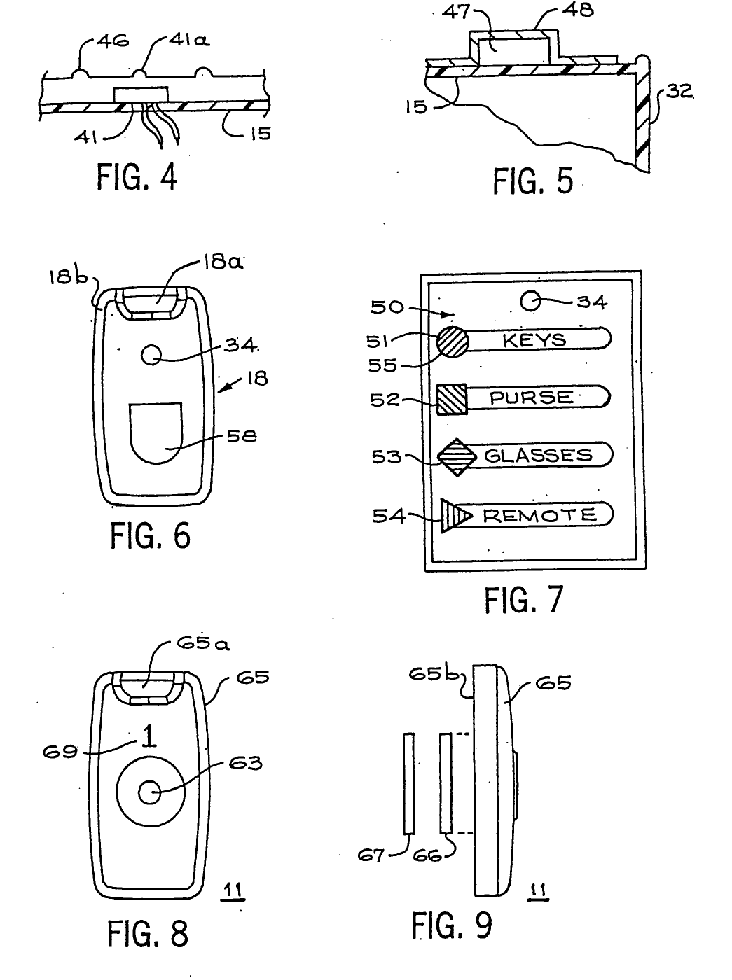

The selecting apparatus 15 comprises a switch pad 15A, which is mounted on an upper panel 36 of the case 32. The switch pad includes a “master” switch 40 and four or more “target” switches, such as switches 41-44. In one embodiment, the switches 40-44 are membrane-type switches providing tactile feedback in the form of raised portions on the surface of the switch. In one embodiment, the switch 41 includes a single raised portion 41a, and the switch 42 includes two raised portions 42a-42b. The switch 43 includes three raised portions 43a-43c, and the switch 44 includes four raised portions 44a-44d. Referring also to FIG. 4, each of the switches, such as switch 41, includes a dome area 45 ringed by an annular rib 46. Each of the four “target” switches 41-44 is used to cause transmission of a different one of four coded RF signals. The “master” switch is used to cause transmission of a further coded RF signal. FIG. 7 shows a further embodiment of a switch pad 50 which includes membrane-type switches 51-54 providing tactile feedback in the form of raised ribs 55 on the surface of the switches.

Referring to FIGS. 2-5, panel 36 includes a region 38 adjacent to the switches having labels 39 secured thereto for associating each of the switches 41-44 with a different one of the objects to be located. The labels are contained within compartments 47 at one side of the switches. The compartments 47 are defined by stepped surface portions 48 as shown in FIG. 5. The stepped surface portions 48 are open at one end 49 to allow insertion of the labels 39, which can be of any suitable material. The outputs of the switch pad 15A are connected to a data input 37 of the microprocessor 33.

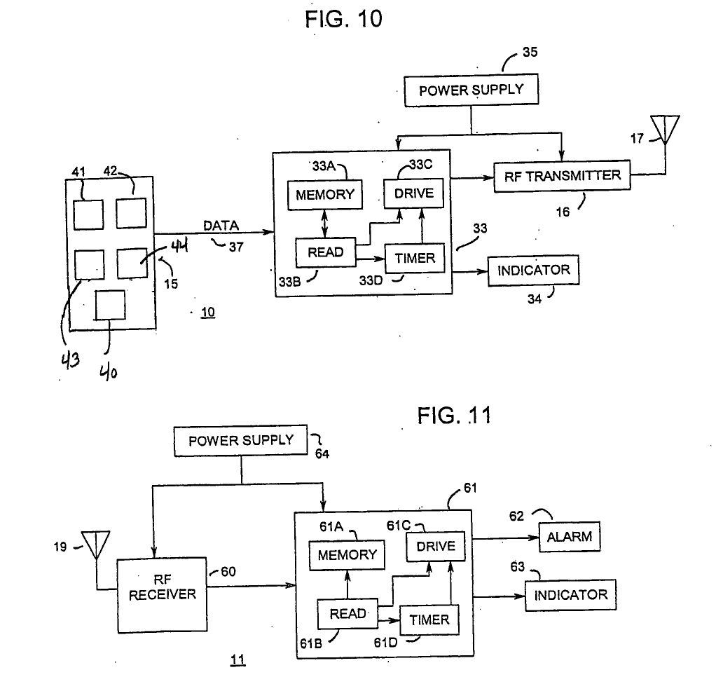

Referring now to FIG. 10, the microprocessor 33 of the transmitter unit includes a memory 33A, a central processing unit (CPU) 33B, which is labeled “read”, a drive component 33C and a timer component 33D. Preferably the functionality of at least the timer component 33D is implemented by software. The memory 33A can include one or more read-only memory (ROM) devices for providing permanent storage for address codes, for example, and one or more random access memory (RAM) devices. As will be shown, the address codes include multiple target address codes and at least one master address code. The address codes uniquely identify items to be located and can be used to configure electronic tags to provide specific responses, such as producing an audible and/or visible output when activated, selecting the duration of time for which the audible and/or output is provided, and selecting the time or a number of times that the audible and/or output is provided in a given day or other time interval. The microprocessor 33 can include suitable interface circuits interposed between the inputs/outputs of the microprocessor and switch pad 15A, the RF transmitter 16 and the indicator 34, for example.

The microprocessor 33 is programmed to monitor the switches 40-44 to detect when one of the switches 40-44 is being operated, determine which switch is being operated and cause the properly coded RF signal to be transmitted. Each of the switches 40-44 is associated with a different one of the address codes stored in the memory 33A. The CPU 33B of the microprocessor 33 responds to operation of one of the switches 40-44 to read-out the associated address code from the memory 33A and apply the address code to the drive component 33C, which responsively controls the RF transmitter 16 to transmit the corresponding coded RF signal. In one embodiment, the RF signal transmitter 16 produces four differently coded RF signals, each corresponding to a different one of the switches 41-44. Each coded signal represents a unique address for a different one of the four electronic tags 11-14. As will be shown, each electronic tag stores its assigned address code allowing the electronic tag to respond to an RF carrier signal modulated with the address for the electronic tag.

Moreover, a further coded RF signal, representing an address to which all four electronic tags respond, can be used to activate all four electronic tags at the same time. The coded matter signal is transmitted in response to operation of “master” switch 40. Each electronic tag of a group of electronic tags stores the master address code in addition to the target address code, allowing all of the electronic tags of the addressed group of electronic tags to be activated at once upon depression of the master switch.

The coded RF signals can also include suitable error detection information as is known in the art. The coded RF carrier signal is produced for a fixed time duration for each operation of one of the switches 40-44. In one embodiment, the RF carrier signal is active for approximately ten seconds. The duration of the RF carrier signal can be implemented in controller software or hardware, allowing the duration of the RF carrier signal to be changed.

While only one transmitter unit 10 is described with reference to the finder systems shown in FIGS. 1, 1A and 1B, in other applications a plurality of transmitter units can be used such that the same 315 MHz carrier frequency is used for all of the transmitter units, as will be described. However, different transmitter units can produce different address codes, allowing unique identification of items or groups of items to be located. In one contemplated embodiment, the transmitter unit also transmits a “branding” signal for “branding” electronic tags. Each transmitter unit stores a randomly generated identification code that is generated once upon first power or upon simultaneous operation of two of the switches on the switch pad for a preselected time. Each tag, upon power up (such as when a battery is installed) enters a learn mode. An activation request by any transmitter unit will brand the electronic tag to that transmitter unit. The “branding” of the electronic tags to a specific transmitter unit ensures that one transmitter unit will not activate electronic tags associated with another transmitter unit while co-located.

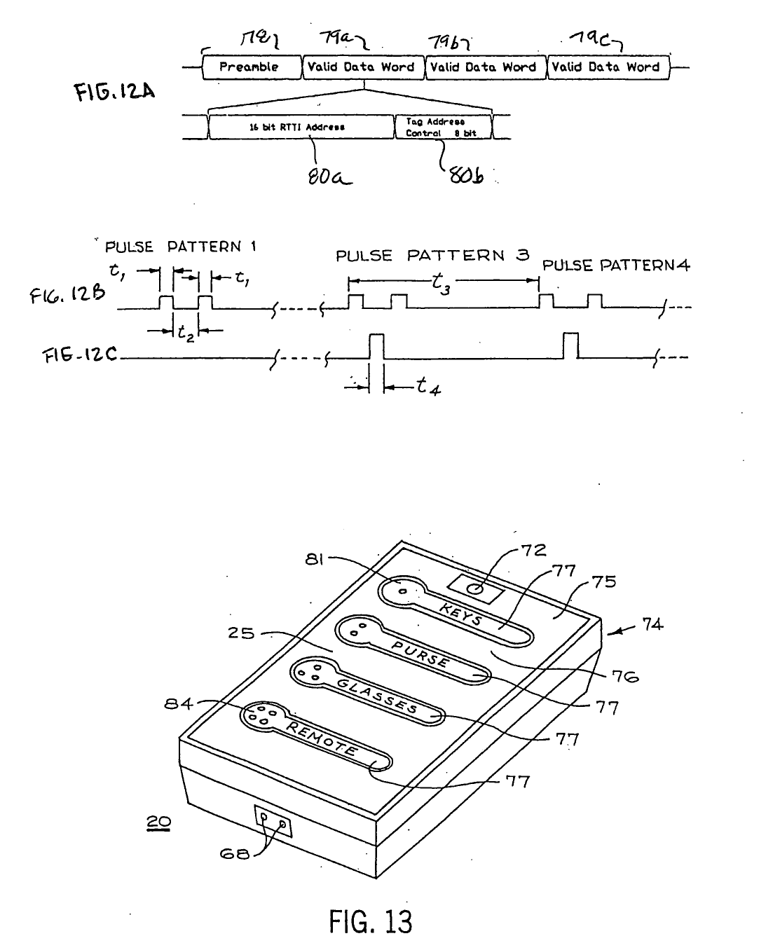

Referring to FIG. 10, the RF transmitter 16 produces a carrier frequency at 315 MHz and is operated under the control of the microprocessor 33. The microprocessor 33 modulates the RF carrier signal, encoding the RF carrier signal with unique address data. The coded RF carrier signal transmitted by the RF transmitter 16 selectively activates the electronic tags 11-14 located within the transmitting range of the transmitter 16. In one embodiment, on-off shift keying with non-return-to-zero (NRZ) encoding is used for modulating the carrier signal in accordance with the packet protocol shown in FIG. 12A, producing tone bursts at least 1.5 seconds in duration as will be described.

Referring to FIG. 12A, the packet protocol for the object locator system includes a preamble 78, and three data packets 79a, 79b and 79c. The preamble 181 contains a data pattern that “wakes up” or activates circuits of the electronic tags and provides a data recovery clock. The coded RF signal transmits a number of data packets over a two second period.

By way of example, the preamble can include 1800 bits. The three data packets 79a-79c are identical and three data packets are transmitted to ensure that a complete message is receivable by the receiver. Each data packet, such as data packet 79a, includes an RTTI address 80a and a tag address control 80b. The RTTI address 80a is a sixteen bit word that “brands” co-located electronic tags to the transmitter unit 10. The tag address 80b is an eight-bit word, including three address bits and five control bits. Only three address bits are required to provide unique addresses (of the 64,000 addresses available) to identify up to eight electronic tags because of the function of the RTTI bits. The control bits can be used to cause the addressed electronic to provide a specific response as will be described.

Referring to FIGS. 1, 1A, 1B and 10, the transmitter unit 10 can transmit several different address codes to activate a various number of electronic tags. The address codes include target codes that are selectable using the transmitter unit 10 to identify a particular electronic tag attached to a particular item. In addition, a second address code is identified as the master code and is used as a common address to identify a number of electronic tags that are attached to a number of separate items, which are selected by the user to be part of a group or family of items.

In one embodiment, there are 64,000 address codes available for use as addresses for the electronic tags. These address codes are selected and used to address specific items. The large number of available address codes minimizes the possibility of using two address codes in the same area, or range, resulting in code interference.

As is described above, certain groupings of the address codes can be set aside for specific uses. For example, a range of 5,000 address codes can be assigned for use as master address codes only. The master address codes are used only in the master address code fields in the transmitter/receiver system. The master address code group is defined as a group of two or more items that are selected by the user to be included as being activated by the single master address code. The user can change the master address codes and items can be deleted or added as needed. By defining the master address codes at the transmitter unit 10 as a user group, address codes are used for the master wake-up selection.

In addition to uniquely identifying items to be located, the address codes can be used to configure electronic tags to provide specific responses, such as producing an audible and/or visible output when activated, selecting the duration of time for which the audible and/or output is provided, and selecting the time or a number of times that the audible and/or output is provided in a given day or other time interval. To this end, the five control bits of the address code can be used to cause the addressed electronic tag to provide a specific response. For example, a default value for the control bits can be used to produce the drive pulse patterns for the audible and/or visual indicators, as shown in FIGS. 12B and 12C, as will be described. Alternatively, one of the control bits can be changed to cause a different drive pulse pattern to be produced for the audible and/or visual indicators.

Moreover, a particular control bit can be used to control timing functions in the microprocessor of one or more of the electronic tags. The transmitter unit 10 can be programmed to transmit a coded RF signal at a specific time each day for a number of days. The timer component 33D of the microprocessor 33 can establish transmission times for the transmitter unit 10. This “timer code” can be used in an application for locating medication containers, such as prescription bottles, for example, and/or reminding an individual to take a medication. A range of address codes can be assigned for use as “timer codes” only. Alternatively, the microprocessor of one or more electronic tags can be programmed to respond to a coded address that causes the electronic tag to automatically produce an audible and/or visual indication at a predetermined time or times each day. In a preferred embodiment, one type of electronic tag is dedicated for applications employing the use of “target” and “master” address codes and the duration of the audible and/or visual indications are set to the pulse patterns illustrated in FIGS. 12B and 12C. A second type of electronic tag is dedicated for applications employing “timer codes”. In this way, the number or controls or customization of the electronic tags using the transmitter unit is minimized. Alternatively, the transmitter unit can be used to reconfigure one or more electronic tags, by changing control bits, for example. The transmitter unit can be placed in a programming mode by the entry of a preselected sequence, using the select switches 40-44 or by adding separate programming keys or switches.

The transmitter unit 10 can be battery powered by a standard 9 volt alkaline battery (or two 1.5 volt AA batteries) and the power supply circuit 35 can include a voltage regulating circuit for providing a regulated DC voltage for the electronic circuits of the transmitter unit. In one embodiment, the circuits of the transmitter unit 10, as well as the circuits of the electronic tags 11-14, such as electronic tag 11 shown in FIG. 11, are operated in a power saving mode to minimize power drain on the battery. The wake-up timer can be implemented through the use of a counter or timer or can be software implemented. Preferably, the wake up timer is implemented within the microprocessor. The wake-up timer in the electronic tags periodically signal the microprocessor to activate the RF signal receiver 60 to look for a transmission and shut down the RF receiver unless a coded RF signal is being received. In applications in which the transmitter unit can be located at a fixed location, the transmitter unit 10 can be powered by an external UL class 2 wall transformer (not shown) providing a 9 VDC output.

The indicator 34 can be mounted on the front panel 36. In one embodiment, the indicator 34 is a light emitting diode. The indicator 34 indicates when any of a coded RF signal is being transmitted in response to the operation of one of the switches 41-44. The light emitting diode 34 can be red or some other distinctive color. The indicator 34 is connected to an output of the microprocessor 33 which provides a driving signal for the indicator 34 in response to the operation of any one of the switches 41-44.

Referring again to FIG. 6, the master transmitter unit 18 includes a switch 58 which causes the master coded RF signal to be generated, resulting in the simultaneous activation of the multiple electronic tags. The master transmitter unit 18 stores a master address code that identifies a plurality of items to be located. By way of example, the number of items is not limited to four, for example, but can be dozens or even hundreds of items, making the master unit particularly applicable for use in a retirement home, a nursing home or other type of assisted care facility. The master transmitter unit 18 can be used to activate electronic tags associated with a plurality of objects, with each of the tags including the master code address of the transmitter unit 18 stored in electronic memory. One application of the master transmitter unit 18 is in a retirement home, a nursing home or other type of assisted care facility for locating items left behind by several residents of the facility. For example, when the residents return to their own rooms after a gathering in a common meeting room, it is generally the case that several of the residents will forget personal items, such as eyeglasses, keys, purses, for example. When the residents have left the meeting room, or even while they are in the process of leaving the meeting room, a person in charge can operate the switch 55, activating the electronic tags carried by items being left behind in the room. The items can then be collected and returned to their owners. The master transmitter unit 18 includes a key ring attachment feature 18a formed in its case 18b which allows the master transmitter unit to be attached to any item.

Electronic Tag

Referring to FIGS. 8, 9 and 11, the electronic tags 11-14 are identical and accordingly only one electronic tag 11 is described. The electronic tag 11 includes a RF signal receiver 60, a microprocessor 61, an alarm generator 62, an indicator 63, a power supply circuit 64 and a case 65 for containing the components of the electronic tag. In one embodiment, the case 65 is made of a durable plastic. The back 65b of the case 65 can be smooth so that the electronic tag can be attached, using double sided tape, to a TV remote control or other surface that cannot be attached to by a key ring, for example. In addition, the case 65 is adapted with a slide cover (not shown) to facilitate replacement of the battery. Each electronic tag can have an Arabic numeral, indicated at 69, from one to four to facilitate identification by an elderly user.

The RF signal receiver is tuned to the 315 MHz frequency range of the RF carrier signal. The RF receiver receives the carrier signal with the data packets. The same 315 MHz frequency carrier signal is used for the receivers of all of the electronic tags. The programmed target and master addresses link the receivers of the electronic tags to the transmitter of the transmitter unit 10.

The microprocessor 61 includes a memory 61A, a central processing unit (CPU) 61B, which is labeled “read”, a drive component 61C and a timer component 61D. Preferably the functionality of the timer component 61D is implemented by software. The memory 61A can include one or more read-only memory (ROM) devices for providing permanent storage for address codes, for example and one or more random access memory (RAM) devices. The memory 61A stores at least the target address code and the master code. The target address code is used for a specific target electronic tag while the master address code allows the electronic tag to respond to a common signal for multiple tags.

As is described above, each electronic tag of a group of electronic tags stores a master address code in addition to a target address code, allowing all of the electronic tags of the addressed group of electronic tags to be activated at once. In addition, the control bits of the address codes enable control of the response of the electronic tag to a coded address. In the preferred embodiment of the invention, the target address code and the master address code are both programmed into the memory 61A prior to the electronic tag leaving the manufacturing facility. These same codes are also programmed into a corresponding transmitter unit.

The power supply circuit 64 can include a battery. In one embodiment, the battery is a high capacity lithium battery.

As described above, the circuits of the electronic tags 11-14, such as electronic tag 11 shown in FIG. 11, are operated in a power saving mode to minimize power drain on the battery. The wake-up timer can be implemented through the use of a counter or timer or can be software implemented. Preferably, the wake up timer is implemented within the microprocessor. The wake-up timer in the electronic tags periodically signal the CPU 61B to activate the RF signal receiver 60 to look for a transmission and to periodically deactivate the RF receiver 16. The RF receiver 60 is maintained activated whenever a coded RF signal is being received. The wake-up timer can be timer 61D or a separate component.

The RF signal receiver 60 is activated periodically to detect coded RF signals. When a coded RF signal is detected, the RF signal receiver 60 recovers the encoded address data and applies the address data to the CPU 61B. The CPU 61B compares the received address data with the address data stored in the memory 61A and if a match is detected, the drive component 61C is activated to enable the audible alarm device 62 and/or visual indicator device 63. The audible device 62 can produce a tone that is provided intermittently a beeping sequence. A special tone beeping can be selected for specific uses.

The RF signal receiver 60 receives the coded RF signals transmitted by the transmitter unit 10 and converts the coded RF signals to digital signals, which are supplied to the microprocessor 61. The microprocessor 61 can include suitable interface circuits interposed between the inputs/outputs of the microprocessor and the RF receiver 16 the alarm generator 62 and the indicator 63, for example.

The microprocessor 61 is programmed to detect the address code and validate the address. The microprocessor 61 is further programmed to cause the audible alarm device 62 to produce an audible output for a fixed time for each address signal received.

In one embodiment, the audible alarm generating device 62 is a piezo sound device or piezo-electric transducer. When activated, the piezo-electric transducer is pulsed twice during each of six two second intervals, as shown in FIG. 12B. The pulse pattern includes a pulse of a first duration t₁, followed by a pause of a duration t₂, and then a second pulse of the duration t₁. This pulse pattern (or duty cycle) is repeated for a total of six times, at a rate t₃. In one embodiment, the duration t₁ is 0.5 seconds, the duration t₂ is 1 second and the rate t₃ at which the pulses are provided is 5 seconds. However, other pulse durations and pulse rates can be used. The frequency of operation can be 1800-2200 Hz. The power level is greater than 85 dBs at one foot. This frequency and power level enable an elderly person, with a limited hearing impairment to be able to hear and identify the location of the electronic tag. However, the alarm generator 62 can be any suitable transducer capable of producing an audible output signal when activated, and different frequency and power levels can be used.

Alternatively, the audible alarm device 62 can be a sound sampler that can record and hold a sound sample from various recordings. By way of example, the sound sample can be the sound of a car horn, the sound of a drum, the sound of a car starting up. The particular sound contained in the sound sampler can be selected as a function of application.

In one embodiment, the indicator 63 is flashed for a duration t₄ occurring during the “off time” (t₂) between the sound pulse patterns produced by the transducer of the alarm generator as shown in FIG. 12C. In one embodiment, the duration t₄ is 0.25 second. This occurs only for the third to the sixth pulse patterns (only pulse patterns 1, 3 and 4 are shown) to enhance battery life. However, the duration and frequency at which the indicator is energized can be other values depending upon battery power available for example.

A medication container can have a longer sequence, such as a one minute tone sequence. The container can include a manual off button, allowing the user more time to locate the container. When the container is picked up to take the medication, the receiver is turned off. Additional tone sequences and sound sampling can be selected for specific needs.

Address codes stored by the electronic tag allow the electronic tag to self-activate at specific times. The electronic tag can cycle to be deactivated after certain sequences or timed operations, or the electronic tag can be turned off manually using a reset switch or button on the tag. For example, the timer 61D can be “primed” in response to the receipt of a “timer address code” to periodically activate the audible and/or indicator devices.

The electronic tag 11 includes a key ring attachment feature 65a (i.e., an opening therethrough) which allows the electronic tag 11 to be attached to any item, such as keys, a purse zipper, a book-mark, that has a hole therein. In one embodiment, the electronic tag is removably attached to an object by hook and loop type fasteners, including a first portion 66 that is secured to the electronic tag and a second mating portion 67 that is secured to the object to be located. However, other types of attachment means, such as straps, double-sided tape, a key ring and the like, can be used. Although the electronic tag 11 is shown to be contained within a case 65, in some applications, the electronic tag can be in the form of a flat chip element (not shown) that is enclosed within a protective coating. The chip as well as is protective coating can be somewhat flexible allowing the electronic tag to be wrapped around a container, for example. This facilitates attaching the electronic tag to an object such as a or medication container or pill bottle and the like.

When a target switch on the transmitter unit is activated, either manually or by way of frequency signals transmitted via the communication link, a coded RF signal is transmitted with a preselected address code in the data packet. This transmission is sent for two seconds.

All of the electronic tags within the transmitting range of the transmitter unit 10 receive the coded RF signal. The read circuit reads the preamble code and the address code(s) shown in FIG. 12A, and compares the address code with the codes stored in the memory 61A. If there is no match, the electronic tag ignores the signal and cycles off. However, if the received code matches one of the stored codes, the receiver of the electronic tag provides an appropriate response. For example, microprocessor 61 activates the audible alarm device 62 and/or the indicating device 63. The audible alarm device and the indicating device are activated for a programmed number of pulses. At the end of the series of pulses the audible alarm device and the indicating device are deactivated. If, in the case of a medication container for which the sound pulses are of a longer duration, a manual button or switch associated with the electronic tag secured to the medication container, or a cap for the container, can deactivate the receiver circuit of the electronic tag to silence the alarm.

Telephone Interface

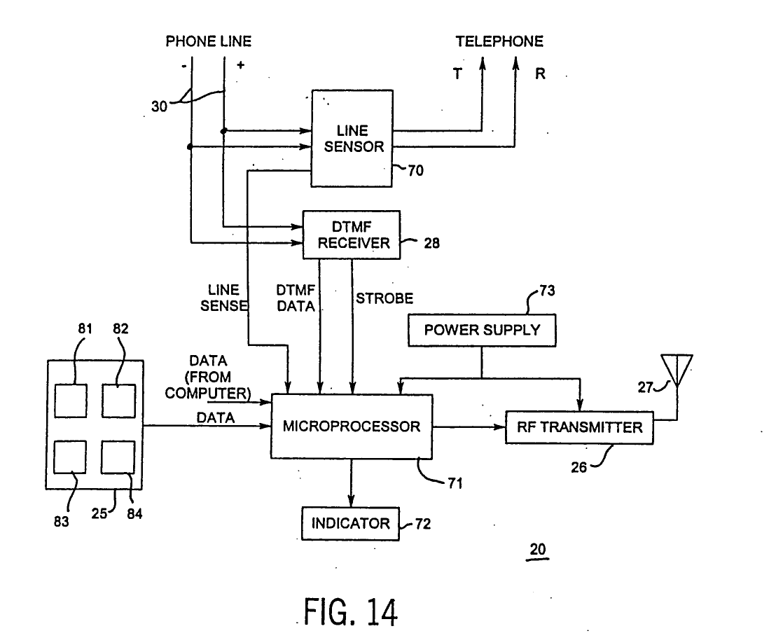

Referring to FIGS. 13 and 14, the telephone interface unit 20 includes the selecting apparatus 25, the RF transmitter 26, the multi-frequency receiver 28, a telephone line condition sensor 70, a microprocessor 71, an indicator 72 and a power supply circuit 73. The microprocessor 71 is similar to microprocessor 33 (FIG. 10) of transmitter unit 10. In one embodiment, the components of the telephone interface unit 20 are housed within a common case 74 having an upper panel 75. However, the telephone interface unit 20 can be a modular unit with components such as the line condition sensor 70 and the multi-frequency receiver 28 being separate from the other components of the telephone interface unit, for example.

The line condition sensor 70 is connected in series with the telephone line 30 and the telephone 31 for detecting an off-hook condition for the telephone, or of an extension telephone 31a. The line condition sensor 70 provides an output LINE SENSE that becomes active for an off-hook condition for the telephone. In one embodiment, the line condition sensor 70 is a line sense relay. One line sense relay suitable for this application is the type M-949-01 Line Sense Relay, which is commercially available from Teltone Corporation, Bothell Wash., 98201.

The multi-frequency receiver 28 is connected across the telephone line 30 (in parallel with the telephone 31) for detecting multi-frequency signals being transmitted on the telephone line and for decoding the multi-frequency signals into digital signals. The multi-frequency receiver 28 has a data output connected to a data input of the microprocessor for supplying the digital signals to the microprocessor. The multi-frequency receiver 28 has a strobe output connected to a further input of the microprocessor 71 for providing an indication to the microprocessor 71 that multi-frequency signal data is available. In one embodiment, the multi-frequency receiver is a dual tone multi-frequency (DTMF) receiver. One dual tone multi-frequency receiver 28 suitable for this application is the type M-8870 DTMF Receiver, which is commercially available from Teltone Corporation, Bothell Wash., 98201.

In one embodiment, the telephone interface unit 20 includes two RJ-11 telephone jacks 68 to facilitate connection of the telephone interface unit 20 in circuit with the telephone line 30 and the telephone set 31. The telephone jacks 68 can be located on any of the side of the case 74, or even on the bottom of the case 74. The telephone interface unit 20 is connected in parallel with the telephone set 31 and monitors for DTMF signals during an active phone call. The telephone interface unit 20 does not load the telephone line. The telephone set 31, with which the telephone interface unit 20 is associated, must be actively in use during a telephone call for the decoding of the DTMF signals. However, the selecting apparatus 25 can be used to enter activation commands for either on-hook or off-hook conditions for the telephone 31. In one embodiment, the selecting apparatus 25 is a switch pad including four membrane-type switches 81-84.

The switch pad 25, which is similar to switch pad 15A, can be mounted on panel 75 and includes four or more membrane-type switches 81-84 providing tactile feedback in the manner similar the switches 41-44 of switch pad 15A as described above with reference to FIGS. 2-5. Each electronic tag of a group of electronic tags stores a master address code in addition to a target address code, allowing all of the electronic tags of the addressed group of electronic tags to be activated at once. Each of the four switches 81-84 is used to cause transmission of a different one of the four coded RF signals. The outputs of the switch pad 25 are connected to data inputs of the microprocessor 71. The panel 75 includes a region 76 adjacent to the switches having labels 77 secured thereto for associating each of the switches 81-84 with a different one of the objects to be located. The labels 77 are contained within compartments at one side of the switches 81-84 in the manner of compartments 47 as shown in FIG. 5. As described above with reference to FIG. 5, the compartments open at one end to allow insertion of the labels 77, which can be of any suitable material.

The microprocessor 71 is programmed to respond to the signal LINE SENSE becoming active to monitor the output of the receiver 28 for DTMF data. When DTMF data is present on input, the microprocessor processes the DTMF data to determine which digit has been transmitted, and causes the proper modulated carrier frequency to be transmitted. The microprocessor 71 is further programmed to detect when one of the switches 81-84 is being operated, to determine which switch is being operated, and to cause the proper modulated carrier frequency signal to be transmitted. The memory of the microprocessor 71 stores the master address code in addition to the target address code, allowing all of the electronic tags of the addressed group of electronic tags to be activated at once. The microprocessor 71 responds to operation of one of the switches 81-84 and produces an output for controlling the RF signal transmitter 26. In one embodiment, the RF signal transmitter 26 produces four coded RF signals and a master address coded RF signal. Each coded RF signal represents a unique address for a different one of the four electronic tags 11-14. The microprocessor 71 can include suitable interface circuits interposed between the inputs/outputs of the microprocessor and the receiver 28, switch pad 25, RF transmitter 26, for example.

The microprocessor 71 is further programmed to produce a randomly generated identification code in the manner known in the art. An identification code is generated once upon first power up or simultaneous selection of a pair of keys of the telephone 30, such as keys 1 and 2, for a predetermined duration of time, such as five seconds. An electronic tag, such as tag 11, upon power up (when the battery is placed in the unit) will enter a learn mode. Any activation of the telephone interface unit 20, at this point, will “brand” the tag(s) to that specific telephone interface unit. The “branding” of the electronic tags to specific telephone interface units ensures that one telephone interface unit will not activate electronic tags associated with another telephone interface unit while co-located.

During the “branding” of the electronic tags, each of the electronic tags receives and stores both a unique target address code stored within the microprocessor 71 and associated with one of the switches 81-84. Additionally, during this same “branding” stage, each of the electronic tags receives a master address code from the microprocessor 71 of the transmitter unit. This master address code is stored within the electronic tags such that the electronic tags can thus respond to both the associated switches 81-84 as well as to the depression of a common, master switch.

The RF signal transmitter 26 is connected to an output of the microprocessor 71. The RF signal transmitter 26 can be the similar in function and operation as the transmitter 16 for the transmitter unit 10. The telephone interface unit 20 is capable of signaling on each of the four system radio frequencies thereby acting as a base unit for the object locating system. The RF signal transmitter 26 can include an antenna 27 for radiating the coded RF signals.

The telephone interface unit 20 is a local and remote control device to activate radio carrier-based tags. The telephone interface unit 20 can be activated either locally through the use of the switches 81-84 of the switch pad 25 or remotely through the monitoring of conventional dual tone multi-frequency signals on a standard telephone line of a public switched telephone network. In one embodiment, channel or DTMF code 1 is digit 1 (frequency pair 697 Hz and 1209 Hz), channel or DTMF code 2 is digit 2 (frequency pair 697 Hz and 1336 Hz), channel or DTMF code 3 is digit 3 (frequency pair 697 Hz and 1477 Hz) and channel or DTMF code 4 is digit 4 (frequency pair 770 Hz and 1209 Hz). DTMF code 5 (frequency pair 770 Hz and 1336 Hz) activates all tags of a group (by causing a master address code to be transmitted), DTMF code 6 (frequency pair 770 Hz and 1477 Hz) activates the transmitter unit into the normal annunciation mode, and DTMF code 7 (frequency pair 852 Hz and 1209 Hz) activates the transmitter unit into the extended annunciation mode. The DTMF code 6 can represent the default value for the control bits can be used to produce the drive pulse patterns for the normal annunciation mode for the audible and/or visual indicators as is described above with reference to FIGS. 12B and 12C. DTMF code 7 can be used to produce the extended annunciation mode. Alternatively, changing of one of the control bits can produce a different drive pulse patterns for the audible and/or visual indicators. In addition, a further DTMF signal, including frequency pair 941 Hz and 1209 Hz, corresponding to the “* key”, (or frequency pair 941 Hz and 1477 Hz, corresponding to the “# key”) is used as a portion of the code activating sequence. While reference is made to specific pushbutton keys for describing the operation of the object locating system, other ones of the available frequency pairs can be used to effect activation of the electronic tags. The radio frequency carrier signal is active for ten seconds for each validly-recognized DTMF tone sequence or each activation of a switch on the switch panel. In one embodiment, a preselected sequence of DTMF tones, such as ** 1, is used to cause the activation of electronic tag 11. Tone sequence ** 2 is used to cause the activation of electronic tag 12. Tone sequence ** 3 is used to cause the activation of electronic tag 13. Tone sequence ** 4 is used to cause the activation of electronic tag 14. Tone sequence ** 5 is used to cause the activation of all of the electronic tags 11-14. Similarly tone sequences ** 6 and ** 7 can be used to activate the transmitter unit into the normal and extended annunciation modes, respectively. Preferably, each tone sequence is followed by a quiet period. Preferably, each tone sequence is followed by a quiet period of about a two second duration.

Alternatively, sequence of DTMF tones, such as #1 is used to cause the activation of electronic tag 11. Tone sequence #2 is used to cause the activation of electronic tag 12. Tone sequence #3 is used to cause the activation of electronic tag 13. Tone sequence #4 is used to cause the activation of electronic tag 14. Tone sequence #5 is used to cause the activation of all of the electronic tags 11-14. Tone sequence #6 is used to cause the activation of electronic tag 13. Tone sequence #7 is used to cause the activation. Similarly tone sequences digits #6 and #7 can be used to activate the transmitter unit into the normal and extended annunciation modes, respectively. Preferably, each tone sequence is followed by a quiet period of about a two second duration.

The indicator 72 can be mounted on the panel 75. The indicator 72 is connected to an output of the microprocessor 71. The indicator 72 provides a visual indication when any of the four carrier signals is active, whether triggered locally via the front panel switches 81-84 or by telephone DTMF signals transmitted on the telephone line and detected by the receiver 28. In one embodiment, the indicator 72 is a red light emitting diode. However, light emitting diodes, or other types of visual indicators, which produce light of color other than red can be used.

In one embodiment, the telephone interface unit 20 is battery powered by a standard 9 volt alkaline battery and the power supply circuit 73 can include a suitable voltage regulating circuit for providing 5 VDC, for example, for the electronic circuits of the telephone interface unit. Alternatively, the telephone interface unit 20 can be powered by an external UL class 2 wall transformer (not shown) providing a 9 VDC output.

Operation

Referring to FIGS. 13 and 14, by way of illustration of the operation of the remote system, it is assumed that a person is unable to locate an item, such as a pair of eyeglasses, and that the person needs assistance in locating the eyeglasses. The person telephones a relative, neighbor or friend, for example, and lets that called party know that the caller is having difficulty locating the eyeglasses. When the caller initiates the telephone call, the line relay operates, causing the output LINE SENSE to become active for indicating to the microprocessor 71 that a telephone call is in progress and that DTMF data may be provided.

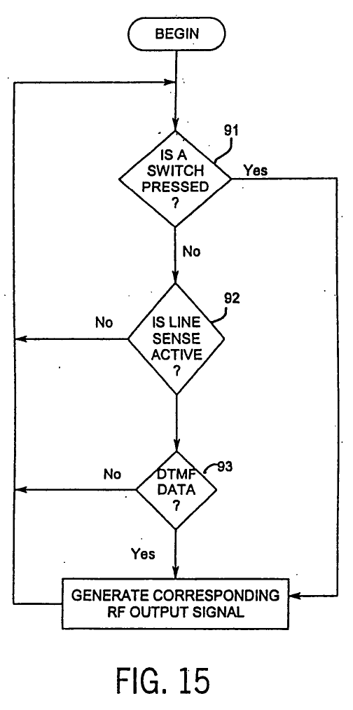

The microprocessor 71 continuously monitors the input from the key pad 25 to determine whether one of the switches 81-84 has been operated, and monitors the input from the line sense relay 70 to determine whether the output LINE SENSE is active. Referring also FIG. 15, if at decision block 91, the microprocessor 71 determines that none of the switches 81-84 of switch pad 25 is depressed, the process continues to decision block 92 which determines whether the output LINE SENSE is active. If not, the program loops back to block 91 to again check the status of the switch pad 25.

When decision block 92 determines that the output LINE SENSE is active, the program steps to decision block 93 and the microprocessor 71 begins to monitor the input from the DTMF receiver on a periodic basis. If a dual tone, multi-frequency signal is not being detected by the DTMF receiver 28, the program loops back to block 91 and again determines whether any one of the key pad switches 81-84 is depressed. Digressing, the microprocessor 71 continues to monitor the output of the key pad 25, block 91, so that the DTMF receiver 28 does not override the key pad 25.

Returning to the example, assuming the called party has answered the telephone and has learned that the calling party needs assistance in locating their eyeglasses, the called party then depresses the “*” pushbutton twice and then depresses the “digit 3” pushbutton on their telephone. In the exemplary embodiment, transmission of the DTMF tone sequence “** 3”, including the DTMF tones corresponding to the digit number “3”, will cause the telephone interface unit 20 to transmit the coded RF signal that activates electronic tag 13 carried by the eyeglasses. The DTMF tone sequence is transmitted to the DTMF receiver 28. The DTMF receiver 28 detects the DTMF tone sequence and provides an appropriate input for the microprocessor 71. As the program continues, the DTMF data provided by the DTMF receiver is detected at block 93 and the program continues to block 94. At block 94, microprocessor 71 processes the DTMF data provided by the DTMF receiver 28 and causes the corresponding RF output signal to be transmitted. In addition, the microprocessor causes the indicator 72 to be flashed. In the present example, the microprocessor 71 determines that the coded RF signal for object #3, i.e., eyeglasses, is to be transmitted. The microprocessor 71 provides a suitable output to the RF transmitter to cause the coded RF signal to be produced and radiated throughout the area. The electronic tag 11 that has the coding responds to the coded RF signal and produces an audible indication for alerting the calling party of the location of the eyeglasses. If the user depresses key #5, causing the transmission of the DTMF tone sequence “** 5”, including the DTMF tones corresponding to the digit number “5”, the telephone interface unit 20 responsively will transmit the master address code for activating all of the electronic tags that are programmed to respond to the master address code.

If the calling party fails to find the eyeglasses in response to the transmission of the DTMF signal. The activation process can be repeated until the lost or misplaced eyeglasses have been located. It is pointed out that the called party also can tell the person seeking the eyeglasses to depress switch 81 which will cause the appropriate coded RF signal to be transmitted. Thus, if at block 91 it is determined that one of the outputs of the switch pad 25 is active, the microprocessor can determine which one of the four switches 81-84 has been operated and can then control the RF signal transmitter to produce the appropriate coded RF signal.

When the eyeglasses have been located, and the telephone conversation is completed, the calling or called party hangs up, which causes the line relay 70 to deactivate the LINE SENSE signal and the object locating system is prepared for the next call.

Monitoring System

The object locating system can be used in a retirement home, a nursing home, or other assisted care facility, which has a central monitoring area on each floor, or otherwise a person designated to assist residents when necessary. In such application, each resident can carry or wear their own transmitter unit, such as transmitter unit 10. The transmitter unit can be activated to produce a signal that is received by a central monitoring station, such as a nurses station on a floor of a nursing home, or by a master control attended by a designated person.

In this system, a resident in his/her room can operate the switch 43 labeled eyeglasses causing a coded RF signal to be transmitted to the central monitoring station. The coded RF signal is received at the central monitoring station, and a person in charge can operate a transmitter unit, such as a control similar to telephone interface unit 20 to transmit coded RF signals to various locations or areas within the nursing home in an attempt to activate an electronic tag associated with the lost or misplaced object allowing the object to be located. The locations to which the RF signal is transmitted can include the resident's room and public rooms on the resident's floor, as well as other locations within the nursing home.

In one preferred embodiment, a person at a central monitoring station can use a computer at that location for causing a transmitter unit, such as a telephone interface unit 20, to transmit coded RF signals to various locations or areas within the nursing home in an attempt to activate an electronic tag associated with the lost or misplaced object allowing the object to be located. In this embodiment, an output of the computer can be coupled to the microprocessor 71 (FIG. 14) of the telephone interface unit 20. The computer is programmed by an object locator program to respond to inputs provided to the computer, such as via the keyboard, to provide digital data signals, similar to those that are produced by the DTMF receiver 28, to the microprocessor 71 to cause the appropriate coded RF signal to be transmitted throughout the facility.

By way of example, it is assumed that one of the residents has misplaced their eyeglasses. That person can alert an attendant at the central monitoring station that assistance is needed in locating the misplaced item. The attendant accesses the object locator program and types in or otherwise enters into the computer the name of the person for whom an item is being sought, and then enters the name “glasses” of the item being sought. The attendant then clicks on a “FIND” icon that is being displayed on the screen of a monitor of the computer, which causes the computer to process the information inputted and to generate the appropriate command for the telephone interface unit 20. The microprocessor 71 responds in the manner similar that for inputs supplied by the switch pad 25 or the receiver 28 and causes transmission of the activating signal for the electronic tag that is carried by the glasses being sought. The activating signal will cause the electronic tag associated with the glasses to produce its audible alarm and its visual indication, so that the glasses can be found and returned to their owner.

Luggage Tag

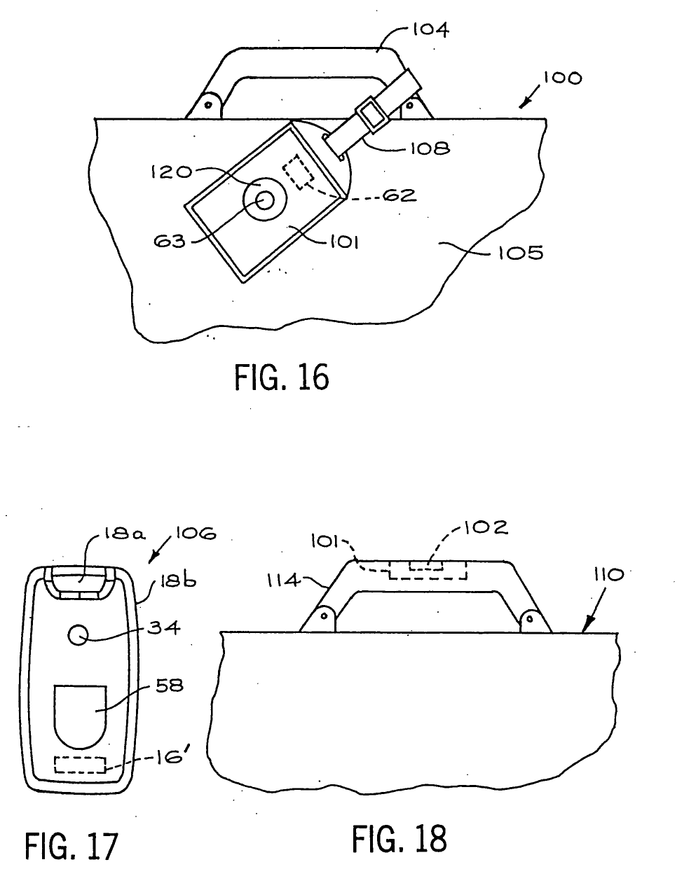

Referring to FIGS. 16 and 17, further in accordance with the invention, there is provided a system for identifying as well as locating objects. In particular, the object identifying and locating system can be used as an electronic luggage identifier and locator for identifying baggage, such as luggage, sporting equipment, packages, and the like which have been checked during travel, such as during a flight on an airplane. In this embodiment, an electronic tag or luggage locator tag 101 (FIG. 16) can be activated by a transmitter unit 106 (FIG. 17) to uniquely identify packages or baggage, such as a piece of luggage 100, where, for instance, the general location of the luggage is known, but where many identical or similar pieces of luggage are being delivered to a relatively large number of people in a common area. An example of this is the baggage return in an airport terminal where the baggage is dispensed from a baggage carousel in an airport and the baggage is being retrieved from the carousel by a large number of people, typically one hundred or more. The luggage locator tag 101 can be similar to electronic tag 11 shown in FIGS. 2-4 and 11. Accordingly, elements of the luggage locator tag 101 have been given the same reference numerals as like or similar components of electronic tag 11. The transmitter unit 106 can be similar to master transmitter unit 18 shown in FIG. 6, which includes components of transmitter unit 10 (FIG. 10) in which the switch pad 15A of transmitter unit 10 is replaced by a single switch 58. Accordingly, elements of transmitter unit 106 have been given the same reference numerals like or similar elements of the transmitter unit 18, and the RF signal transmitter of transmitter unit 106 has been given the reference numeral 16′. In addition, the RF transmitter 16′ of transmitter unit 106 provides only one coded RF signal.

In the object locating system described above with reference to FIGS. 1 and 1A, for example, the transmitter unit 10 (or telephone interface unit 20) is used to activate one of four electronic tags 11-14, for example, of the system. The object identifying and locating system employing the luggage locator tag 101 and the transmitter unit 106 can be considered as a subset of the object locating system wherein a transmitter unit 106 activates a single tag 101, or simultaneously activates a plurality of tags 101 which have the same frequency coding, for allowing a person to identify one or more pieces of luggage as the luggage is being dispensed from a baggage carousel in an airport, for example.

Alternatively, using the two level address coding arrangement described herein, the luggage locator tags for pieces of luggage can respond to both a target code and a master code, allowing the luggage locator tags to be activated individually or to be activated at the same time. That is, each luggage locator tag stores a target code and a master code. When the transmitter unit 106 transmits a target code, only the piece of luggage having the luggage locator tag storing that code will be activated. However, when the transmitter unit 106 transmits a master code, all of the luggage locator tags storing that master code will be activated.

The transmitter unit 106 includes a key ring attachment feature 18a, which allows the transmitter unit to be attached to any item having a hole, and particularly, an item such as a key ring. The transmitter unit 106 includes a pushbutton or switch 58 for activating the RF signal transmitter 16′ of the transmitter unit 106. The transmitter unit 106 includes an indicator 34 for indicating when a coded RF signal is being transmitted by the RF transmitter 16′ of the transmitter unit 106.

In one embodiment, the luggage locator tag 101 includes a piezo electric transducer 62, which produces an audible sound when energized, and an indicator 63 which is lit when energized. The transducer 62 and the indicator 63 can have the same duty cycle as described above with reference to FIG. 12, for like numbered components of the electronic tag 11. The luggage locator tag 101 can be removably secured to the luggage 100. For example, the luggage locator tag 101 can be attached to a handle 104 of the luggage by a strap 108, or can be attached to the outer surface 105 of the luggage in a suitable manner. Moreover, the luggage locator tag 101 can be in the form of a fob or a key ring that can be removably attached to the luggage. Alternatively, the luggage locator tag 101 can be built into the handle 111 of a piece of luggage 110 as shown in FIG. 18.

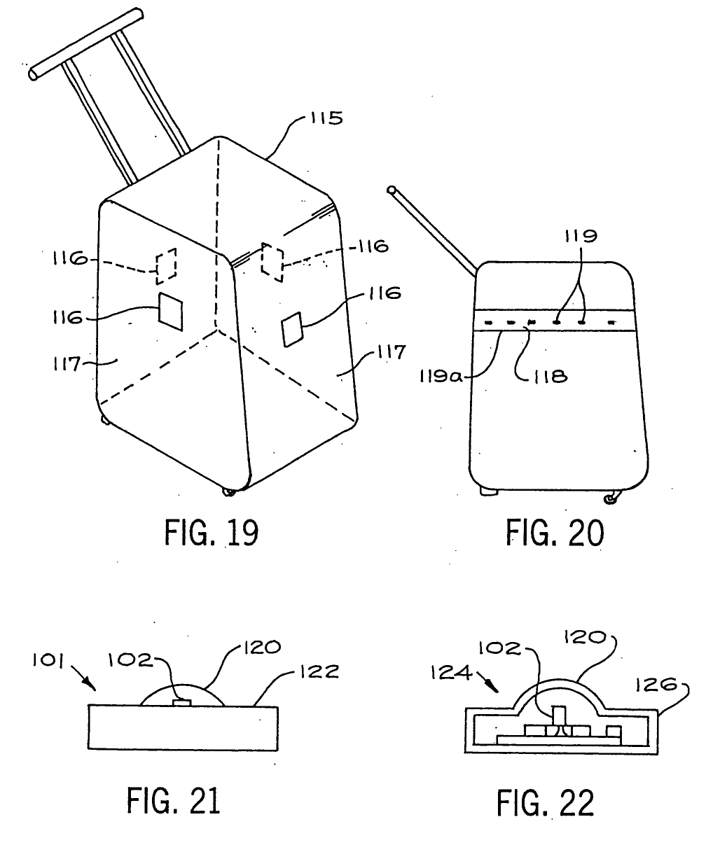

Referring to FIG. 19, in another embodiment, one or more luggage locator tags 116 are incorporated into the fabric or surface 117 of the luggage 115 at locations on each side surface of the luggage. The luggage locator tags 116 both light up and produce an audible signal when activated. Referring to FIG. 20, in a further embodiment, a luggage locator tag 118 is in the form of a strip that can be illuminated. One known type of strip lights includes a string of lights 119 mounted within a sheath 119a of transparent plastic tubing. The lights can be energized in sequence, producing a strobe-like effect. The strip of lights preferably can be built structurally into and incorporated into the fabric and/or a surface structure of the luggage, and can extend 360° around the luggage. The foregoing arrangements are more permanent and the luggage locator tags can be built into the luggage by the manufacturer of the luggage.

Referring to FIG. 21, to enhance the visibility of the light indication produced by the luggage locator tag 101, the luggage locator tag 101 can include a dome or lens 120 for focusing the light to make it more visible. The indicator 63 is located behind the lens, and illuminates the lens when the indicator is activated. The presence of the lens results in the light being “raised” out of the plane 122 of the luggage tag (represented by the upper surface of the luggage tag), making the light indication more readily seen. Moreover, the lens can be colored, with the color being selected to make the luggage to which the luggage locator tag 101 is attached be more distinctive.

Also, because baggage retrieval areas typically are noisy areas, the luggage locator tag can be configured to not produce an audible signal, so that only a light indication is provided. Different colors of light can be provided for different object identifying systems by selection of the type of indicator used. Moreover, as shown in FIG. 22, a luggage locator tag 124 can have a housing 126 of a transparent material increasing the viewability of the indicator 63.

Preferably, the luggage locator tag 101 can provide additional unique physical identification. For example, the housing of the luggage locator tag 101 can itself be of a unique color or pattern. Alternatively, the luggage locator tag 101 can be attached to the luggage by a strap or a band 108 (FIG. 16) which is of a distinctive pattern or configuration that is known to the owner for making the luggage locator tag. In either case, the luggage locator becomes more readily recognizable by the user of the luggage.

Vehicle Key Locator

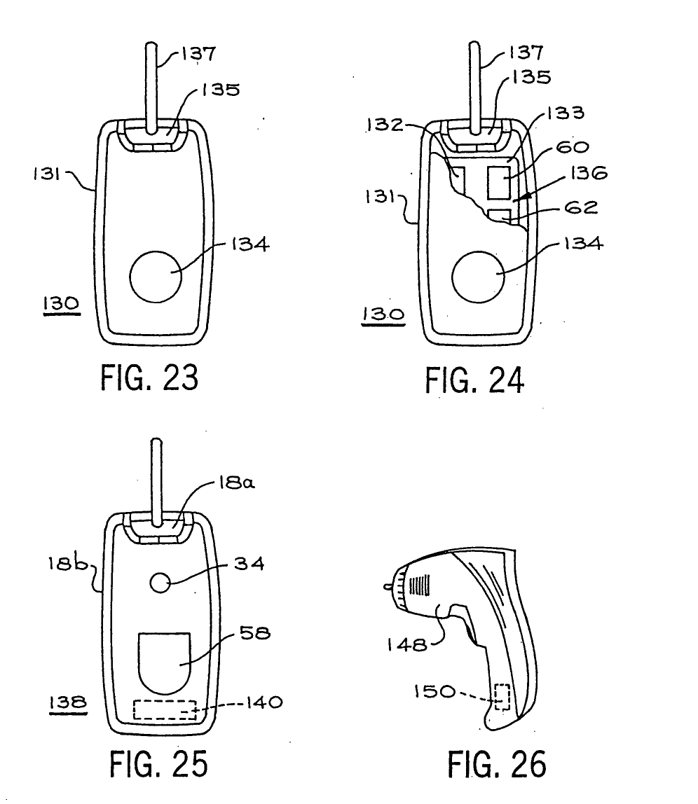

Referring to FIGS. 23-25, further in accordance with the invention, there is provided a system for locating a set of keys for a vehicle. By way of example, the vehicle keys can be attached to a fob 130, which provides remote keyless entry (RKE) for the vehicle in the manner known in the art. The fob 130 includes a housing 131 containing an electronic circuit 132, shown in FIG. 24, including an RF transmitter. The RF transmitter is activated in response to manual operation of a pushbutton 134 mounted on the housing 131. When activated, the RF transmitter transmits a coded RF signal to the vehicle. An RF receiver (not shown) in the vehicle responds to the coded RF signal and unlocks the doors of the vehicle only when a proper coded RF signal is received. The electronic circuit 132 can be mounted on a printed circuit board 133. The electronic circuit 132 obtains electrical power from a battery (not shown) located within the housing. The housing 131 can include a key ring feature 135 for receiving a key ring 137 for holding one or more keys (not shown), including an ignition key for the vehicle.

The vehicle key locating system includes an electronic locator circuit, indicated generally by reference numeral 136 in FIG. 24, can be activated by a transmitter unit 138 (FIG. 25) to locate the keys. The components of the electronic locator circuit 136 can be similar to those of the electronic tag 11 shown in FIGS. 8 and 11. Accordingly, components of the locator circuit 136 have been given the same reference numerals as like or similar components of electronic tag 11. The components of the electronic locator circuit 136 can be similar to those of the transmitter unit 10 described above with reference to FIG. 10. In particular, the transmitter unit and the electronic tag can employ target and master codes, for example, as described herein.

In one preferred embodiment, the components of the electronic locator circuit 136 are integrated into the fob 130. The components of the electronic locator circuit 136 which are integrated into the fob 130 include an RF receiver 60, a microprocessor 61 (FIG. 11), and a piezo electric transducer or other sound emitting device 62 which produces an audible sound when energized. The sound emitting device 62 can be a sound sampler hold a recorded sound sample such as the sound of a car starting up, the sound of a car horn, the sound of a motorcycle, for example. The components of the electronic locator circuit 136, including RF receiver 60, a microprocessor 61 and piezo electric transducer 62, can be discrete components mounted on the printed circuit board 133. Moreover, at least some of the electronic components of the electronic locator circuit 136, such as the RF receiver 60 and the microprocessor 61 can be incorporated into the RKE circuits 132 of the fob. The electronic locator circuit 136 can include an indicator, such as indicator 63 for locator tag 11 (FIG. 8), which is lit when energized. Electrical power for the electronic locator circuit 136 can be provided by the battery for RKE circuits of the fob 130. The sound emitting device 62 and the indicator 63 (when provided) can have the same duty cycle provided under microprocessor control as described above with reference to FIG. 12, for like numbered components of the electronic tag 11. Alternatively, the components of the locator circuit 136 can be enclosed within a housing in the manner of locator tag 11 (FIG. 8) which can be adapted to be attached to a surface of the fob 130 or placed on a key ring attached to the fob.

Referring to FIG. 25, the transmitter unit 138 is similar to the transmitter unit 106 shown in FIG. 17, which, in turn, includes components of transmitter unit 10 shown in FIG. 10. In transmitter unit 106, the switch pad 15A of transmitter unit 10 is replaced by a single switch 58. Accordingly, elements of transmitter unit 138 have been given the same reference numerals like or similar elements of the transmitter unit 106, and the RF signal transmitter of transmitter unit 138 has been given the reference numeral 140. In one embodiment, the RF signal transmitter 140 of transmitter unit 138 provides only one coded RF carrier signal. In the object locating system described above with reference to FIGS. 1 and 1A, for example, the transmitter unit 10 (or telephone interface unit 20) is used to activate one of four electronic tags 11-14, for example, of the system. The object locating system employing the electronic locator circuit 136 and the transmitter unit 138 can be considered as a subset of the object locating system wherein a transmitter unit 138 activates a single electronic locator circuit 136 which corresponds to a single locator tag.

The transmitter unit 138 includes a pushbutton or switch 58 for activating the RF signal transmitter 140 of the transmitter unit 138. The transmitter unit 138 can include an indicator 34 for indicating when a coded RF signal is being transmitted by the RF transmitter 140 of the transmitter unit 138. When not in use, the transmitter unit 138 can be stored in any convenient location, such as on a hook or in a drawer in a kitchen or some other room of a house, for example.

In the event the car keys are misplaced, the user takes the transmitter unit 138 from its storage place and depresses the pushbutton 58. The transmitter unit 138 responsively transmits an RF signal which activates the locator circuit 136, causing the transducer 62 to produce an audible alarm to indicate to the user the location of the vehicle key set. Also, when provided, the indicator is caused to light, producing a visible indication to the user.

Portable Tool Locator

Referring to FIG. 26, further in accordance with the invention, the object locating system can be used for locating a portable hand tool 148, such as a hand drill illustrated in FIG. 26, a portable electric saw, and the like or any other hand tool, such hammers, saws, etc. In this embodiment, a locator tag 150 (FIG. 16) can be activated by a transmitter unit, such as transmitter unit 106 (FIG. 17), to locate the hand tool 148. Professional contractors on a construction site use their tools at different locations on the worksite or at one or more sites at a time. Tools often get misplaced or mistakenly are taken by someone other the rightful owner. On the one hand, a worker can use the object locator system, operating in a “target code mode”, to locate tools that belong to the worker. On the other hand, a foreman or site supervisor can use the object locator system, operating in the “master code mode”, to locate tools left behind by one or more workers at the end of a working shift.

The locator tag 150 can be similar in function to the electronic tag 11 shown in FIGS. 8 and 11. Referring also to FIG. 11, the locator tag 150 includes components of electronic tag 11 including an RF receiver 60, a microprocessor 61, a piezo electric transducer 62 and an indicator 63. The locator tag 150 can include its own power supply 64, such as a battery. The transducer 62 and the indicator 63 can have the same duty cycle, produced under microprocessor control, as described above with reference to FIG. 12, for like numbered components of the electronic tag 11.

In one embodiment, the locator tag 150 is integrated into the hand tool 148 and can be mounted on an interior surface of the housing 152 of the hand tool when the tool housing is of a material capable of passing RF radiation or at any other suitable location within the housing 152 of the hand tool. Alternatively, the locator tag can be attached to an exterior surface of the tool, or can be mounted on a power cord of the hand tool when the hand tool includes a power cord. The components of the locator tag 150 can be enclosed within a housing or can be produced on a substrate suitable for mounting within the hand tool and adapted to be connected to a battery also mounted within the hand tool.

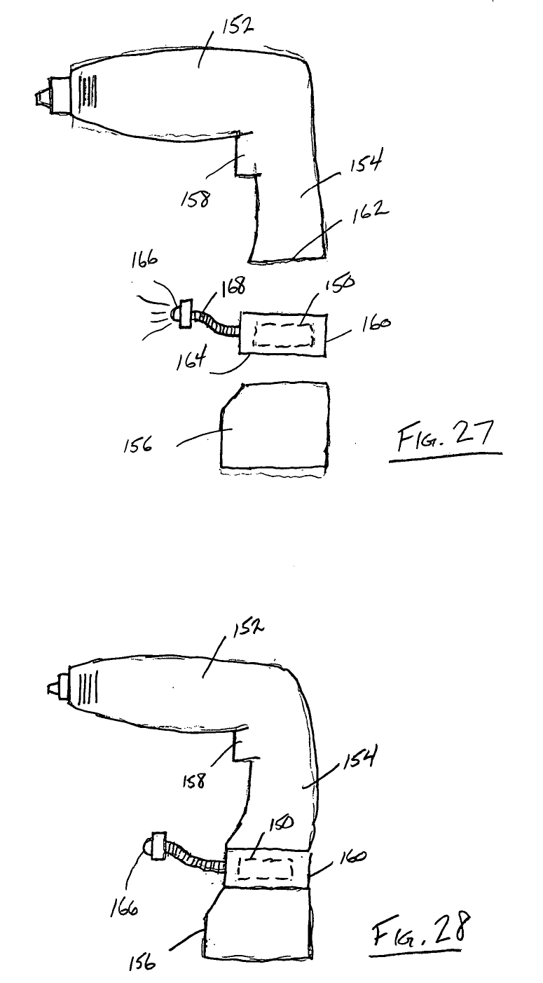

Moreover, in a preferred embodiment of the invention shown in FIGS. 27 and 28, the electronic tag can be retrofit to a tool using an adapter that can be interposed between the power circuit of the tool and a source of electrical power, such as the battery pack by which the tool receives electrical power.

As shown in FIG. 27, the hand tool 152 includes a handle portion 154 that typically receives a battery pack 156. The battery pack 156 can be removed and recharged as is conventionally known in the industry. During normal use, when the trigger 158 is depressed, the stored electrical energy from the battery pack 156 is used to operate the hand tool 152.

In the embodiment of the invention illustrated in FIG. 27, the electronic tag 150 is integrated into an adapter 160. The adapter 160 is configured to be received in the battery terminal 162 formed on the bottom end of the portable tool handle 154. It should be understood that the adapter 160 will be constructed having the required terminals and configuration to be received on the portable tool 152. It is contemplated that various different adapters 160 can be created for the different manufacturers of portable tools.

The adapter 160 further includes a battery terminal 164 that is configured to receive the battery pack 156. In this manner, the adapter 160 is positioned between the portable tool 152 and the battery pack 156. The adapter 160 allows the stored electrical power to flow through the adapter 160 to operate the portable tool 152 in a conventional manner. However, the battery pack 156 provides the required power for operating the locator tag 150.

As illustrated in FIG. 27, the adapter 160 includes a light source 166 mounted to a flexible neck 168. The light source 166 can be any of a wide variety of known light sources. However, in the preferred embodiment of the invention, the light source 166 is an LED that derives electrical power from the battery pack 156. The flexible neck 168 allows the user of the tool to position the light source 166 in the most desirable position to direct the source of light onto a work surface. As illustrated in FIG. 28, when the adapter 160 is mounted to the work tool 152, the adapter is compactly positioned between the battery pack 156 and the tool handle 154 such that it does not interfere with the normal operation of the tool 152.

As illustrated in FIGS. 27 and 28, the adapter 160 including the light source 166 is designed to retrofit on various frames of power tools. As discussed, the adapter is configured to engage both the battery pack 156 and the portable tool 152 depending upon the specific configurations of the tool manufacturer.

In the embodiment of the invention illustrated, the locator tag 150 has an internal design configuration similar to that shown in FIG. 11. However, in the embodiment shown in FIGS. 27 and 28, the locator tag 150 includes a power circuit that is designed to step down the battery power to three volts from the various battery voltages of the battery pack 156. Typically, the battery pack 156 ranges from 9.6 to 24 volts, depending upon the portable tool manufacturer. It is contemplated that the power circuit will include circuitry to step down the voltage to three volts, such that even when the battery pack 156 is discharged such that it does not have enough power to operate the portable tool 152, the battery pack 156 retains enough power to operate the locating circuit within the locator tag 150.

The locator tag 150 operates in the same manner as the prior locator tags shown and described above. Specifically, the locator tag 150 includes the unique target address code such that the locator tag 150 will respond upon receiving the transmitted address code from a transmitter unit. Likewise, the locator tag 150 stores a master address code such that the locator code 150 can respond to the transmission of a master code. Thus, it is contemplated that a worker can depress a master control switch to locate all of the tools owned and being used by the worker at an individual work site.

In one embodiment, the transmitter unit 106 (FIG. 17) activates a single locator tag 150. In such an embodiment, the transmitter unit 106 includes a single pushbutton or switch 58 for activating the RF signal transmitter 16′ of the transmitter unit 106. The RF signal transmitter produces only one coded RF signal. The transmitter unit 106 can include an indicator 34 for indicating when a coded RF signal is being transmitted by the transmitter unit. The transmitter unit 106 and the electronic tag 150 can employ target and master codes, for example, as described herein. This enables the transmitter unit 106 to activate four or more locator tags for locating four or more different hand tools at the same time.

Although the adapter 160 and the battery pack 156 are shown in FIGS. 27 and 28 as being separate components, it is contemplated by the inventors that the locator tag 150 and the light source 166 could be incorporated either directly into the battery pack 156 or the portable tool 152 itself, thereby eliminating the separate adapter 160. This configuration is particularly desirable for the tool manufacturer or the manufacturer of replacement battery packs 156, since the replacement battery pack would include additional features that can be desirable to a user.

In the preferred embodiment of the invention, the light source 166 is activated upon depression of the trigger 158. Preferably, a current sensing circuit contained within the locator tag 150 senses the draw of current by the portable tool 152 and turns on the light source 166. In a preferred embodiment of the invention, the light source 166 remains activated for a predetermined period of time after the release of the trigger 158. In this manner, the light source 166 remains on to allow the user to view the work area, even during brief periods of time when the trigger 158 is no longer being depressed. The duration of the activation of the light source can vary depending upon the user requirements. However, it is contemplated that the duration of time will be approximately ten seconds after the release of the trigger 158.

Medicine Container

As described above, the object locating system can be used to locate a medication container or prescription bottle as well as to function to remind an individual to take a medication. The electronic tag can be attached to the container portion or the cap of a prescription bottle or container to identify the particular container that is being targeted.

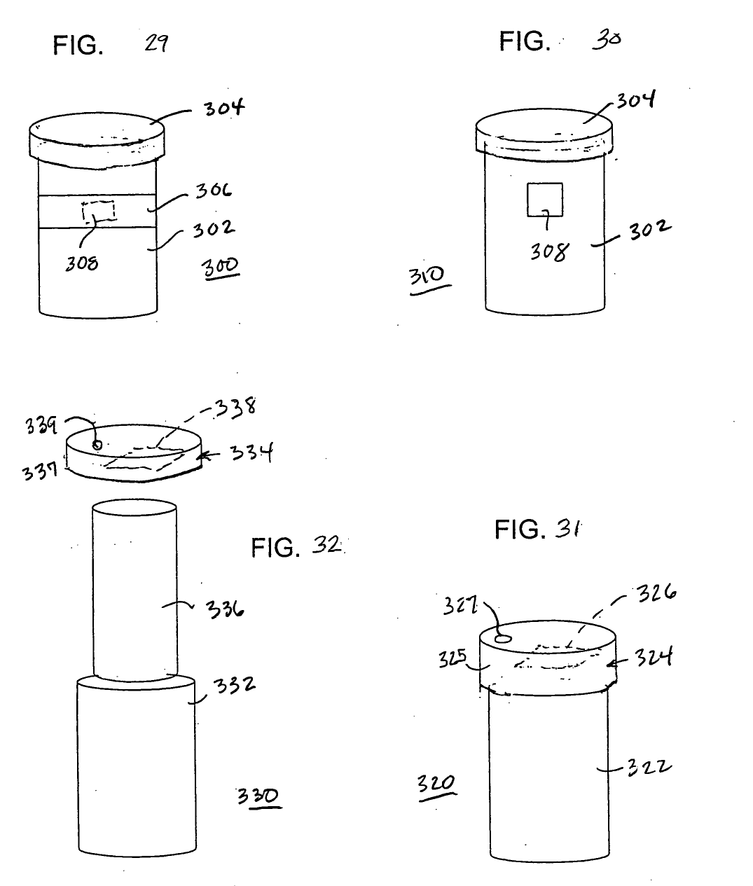

Referring to FIG. 29, in one embodiment, a medication container 300 includes a container 302 and a cap 304 and an electronic tag 306 that is adapted to be wrapped around the container 302 and secured to the container in a suitable manner. In another embodiment 310 shown in FIG. 30, a medication container 310 includes a container 302 with an electronic tag 308 secured to a surface of the container 302, such as the front surface of the container. In the embodiment 320 shown in FIG. 31, a cap assembly 324 includes a cap 325 and an electronic tag 326 that is integrated into the cap 325. The electronic tag can be secured to the inner or outer surface of the cap or can be molded into or otherwise incorporated into the cap. The cap assembly 325 is dimensioned to fit a container 322. The container body or the cap of the medication container 320 can include a manual reset button or switch to allow the user to silence the alarm and turn off the receiver. To this end, preferably the cap assembly includes a switch or button 327 that is coupled to the receiver for resetting the receiver to silence the alarm. The cap assembly 324 shown in FIG. 31 can be adapted to be used as a replacement for a cap on a container the user obtains from a drug store or pharmacy, for example.

In another embodiment, shown in FIG. 32, an electronic tag is incorporated into a cap assembly 334 for a container 332 that is adapted to receive a prescription bottle 336 that is provided by a drug store or pharmacy. The cap assembly 334 can be similar to cap assembly 324 shown in FIG. 49, with the electronic tag can be secured to the inner or outer surface of the cap or can be molded into or otherwise incorporated into the cap. The cap assembly 334 or the container 332 can include a reset switch or button-339 that allows resetting of the receiver to silence the alarm.

The electronic tags used in applications for locating a medication container and/or reminding a user to take a medication, can be configured to have a longer tone sequence or “on time”, such as a one-minute tone sequence, allowing the user more time to locate the medication container. Alternatively, the audible alarm device can be a sound sampler that can record and hold a sound sample from various recordings. By way of example, the sound sample could be a verbal reminder to take the medicine or perform some other related task. The particular sound contained in the sound sampler can be selected as a function of application

The transmitter unit can be programmed to transmit a locating signal at a specific time each day for a number of days. In this embodiment, the receiver follows the transmitter. Alternatively, the electronic tag can provide the timing function with the timer activated in response to the electronic tag being activated by the transmitter and the electronic tag then producing a reminder signal each day or several times a day, for one or more days. As is stated above, the receiver can be reset to the off condition either manually by the operation of a switch located on the container or by operating the transmitter. Moreover, the functions can be effected by a third party, using the remote control function described above wherein a third party causes the transmitter to be activated using a communication link including a computer and/or telephone link as described above.

In the application for a medication container, the alarm indicator can have a longer sequence time, such as a one minute tone sequence, allowing the user more time to locate the container. The manual reset switch or button allows the user to silence the audible alarm. Alternatively, the receiver can be deactivated automatically in response to the container being picked up. Moreover, the electronic tag can be reset on opening the container with a trip switch that is activated or awakened with an addressable wake-up signal code that is programmed into the transmitter unit which signal is sent at a particular time.

Although not specifically shown in the drawings, it is contemplated that the medication container would include a visual signaling device that would aid in locating the medication container. The visual signaling device would typically be an LED that either flashes or remains active upon receiving the target address code from the transmitter unit.

Flashlight Locator

The electronic tags 11-14 of FIG. 1 are shown and described in the drawings of FIGS. 8, 9 and 11. In this embodiment, the electronic tag includes an RF signal receiver 60, a microprocessor 61, an alarm generator 62, an indicator 63 and a power supply circuit 64. As described, the indicator 63 is preferably a visual indicator that flashes or is lit to provide a visual indication of the location of the electronic tags.

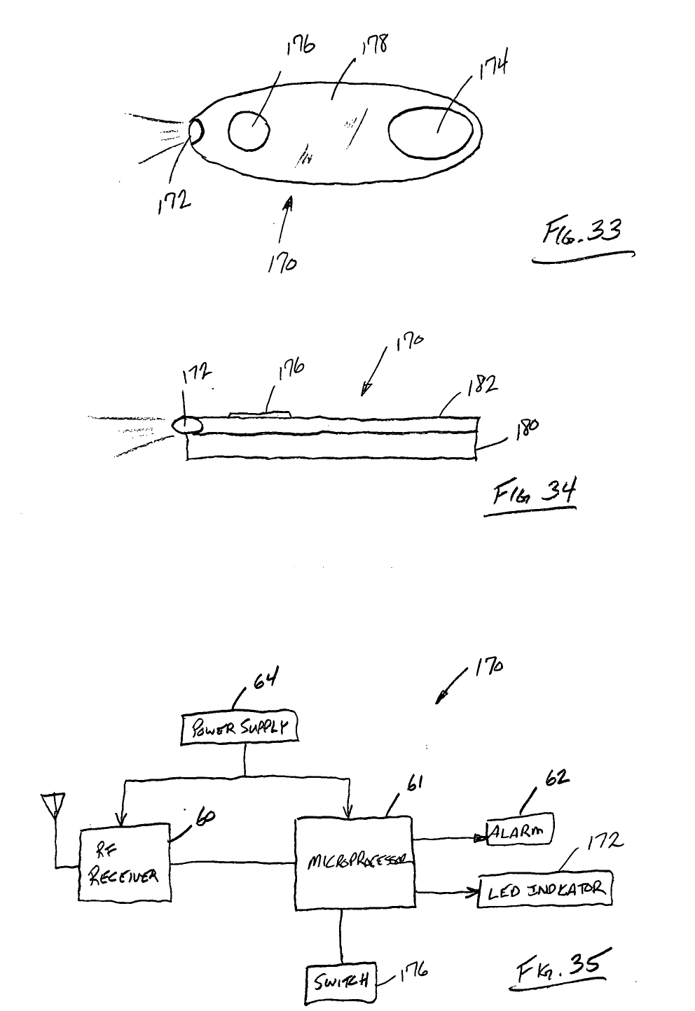

Referring now to FIGS. 33-35, thereshown is an improved version of the electronic tags, as referred to by reference numeral 170. The operating components for the electronic tag 170, as best shown in FIG. 35, include many common elements to the electronic tags shown in FIG. 11. However, in the electronic tag 170, the indicator is replaced with an LED indicator 172. The LED indicator 172 can be operated for a greater period of time due to the minimal energy drawn by an LED during activation. As illustrated, the LED indictor 172 is coupled to the microprocessor 61 and receives power from the power supply 64.

As illustrated in FIG. 33, the electronic tag 170 includes a key ring hole 174 and an activation switch 176 mounted to the plastic housing 178. The LED 172 is mounted near one end of the housing 178 for projecting a beam of light in a desired direction.

In accordance with the present invention, when the activation switch 176 is depressed, power from the power supply 64 is supplied to the LED indicator 172 such that the LED indicator 172 provides a source of light. In this manner, the electronic tag 170 can function as a flashlight in addition to functioning as a locator tag.

Referring now to FIG. 34, thereshown is the schematic illustration of the electronic tag 170. In the embodiment shown in FIG. 34, the electronic tag includes a locator circuit layer 180 that includes all of the locator circuitry as previously described. The locator circuit layer 180 preferably includes the power supply and all of the operating components. Mounted above the locator circuit layer 180 is a flashlight layer 182 that includes all of the operating components for controlling the activation of the LED 172. For example, it is contemplated that upon depression of the switch 176, the flashlight layer 182 includes the required operating components to allow the LED indicator 172 to remain illuminated for a predetermined period of time before shutting off. As an example, it is contemplated that the LED indicator 172 could remain illuminated for 15-20 seconds upon depression of the activation switch 176. Further, it is contemplated that the flashlight layer 182 can include the required circuitry such that upon depression of the activation switch 176, the LED indicator 172 operates in a pulsing mode. In this mode, the rapid activation of the LED 172 would draw attention to the person holding the electronic tag, such as when the owner is in a threatened situation.

As can be understood in FIG. 34, the use of the flashlight layer 182 above the locator circuit layer 180 allows the flashlight layer to be easily added to the locator circuit layer 180. Thus, the locator circuit layer 180 can be used in the other electronic tags previously described that do not include the LED 172. However, if the electronic tag 170 is desired, the flashlight layer 180 can simply be added to the locator circuit layer 180 to control activation of the LED indicator 172.

Integrated Key Locator

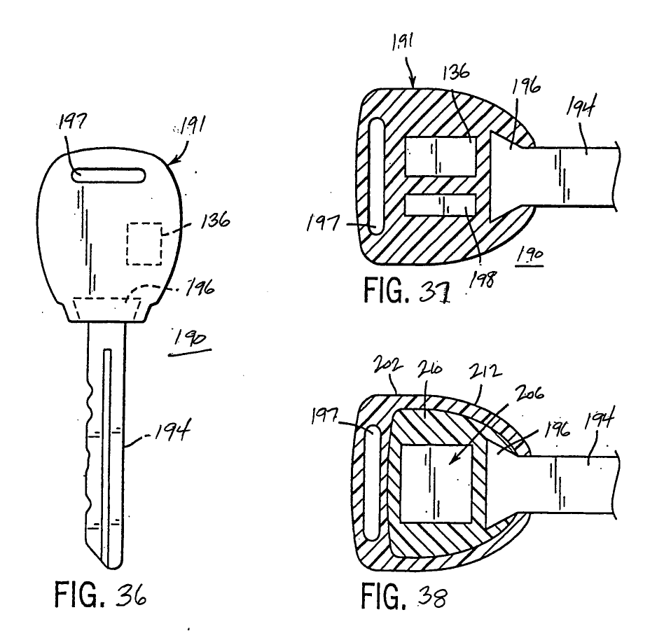

Referring to FIG. 36, in a further embodiment, a key assembly 190 includes a head portion 191 that is integrally molded to the heel end 196 of a key blade 194. The key assembly 190 can include an opening 197 to facilitate attaching the key to a key ring. An electronic locator circuit 136 is molded into the head portion of the key. In one embodiment, the electronic locator circuit 136 is similar to the electronic locator circuit 136 which is contained in fob 130 described above with reference to FIGS. 23 and 24. Referring also to FIG. 24, the electronic locator circuit 136 can include discrete components contained on a printed circuit board 133 and operating in the manner of the electronic locator circuit 136.

FIG. 37 illustrates the key 190 that is produced using a one-step molding process. Block 136 represents the electronic locator circuit. A further block 198 represents a transmitter for a remote keyless entry system (RKE), or a transponder for a radio frequency identification system (RFID), for example. In this embodiment, the components of the electronic locator circuit can be mounted within a premolded housing, or carrier, or be encapsulated in a plastic material prior to being molded onto the heel end 196 of the key blank 194. Alternatively, at least the receiver 60 and the microprocessor 61 can be formed as a system on a chip (SOC) device, with the chip device being molded into the head portion of the key using a one-step molding process, for example. The mold used to produce the head portion of the key 190 is adapted to encapsulate the transducer 62 in such a way as to allow the transducer 62 to vibrate when the locator circuit is activated. Moreover, the key of FIG. 37, with the electronic locator circuit including discrete components or being formed as a chip device, can be produced using a two-step molding process.

FIG. 38 illustrates a key 200 which is produced using a two-step molding process to mold a head portion 202 of a plastic material onto the heel end 196 of a key blank 194. A chip device is represented by block 206. The chip device includes the electronic locator circuit and a further circuit, such as a transmitter for a remote keyless entry system (RKE), or a transponder for a radio frequency identification system (RFID), for example. A first plastic material 210, or carrier, attaches the chip device to the key blank. A second plastic material 212, which can be the same as material 210 or of a different material, is molded over the first material 210, the heel end 196 of the key blank 194 and the chip device, forming an outer shell. Moreover, the key 200 of FIG. 38 can be produced using a one-step molding process.

Further in accordance with the invention, there is provided a mounting arrangement which allows the electronic locator circuit 136, including a power source, such as a battery or a circuit capable of producing an energizing signal in response to the activating transmitted by the control unit, which can be control unit 138 for example, associated with the finding device, to be retrofitted to a vehicle or house key, for example. The mounting arrangement includes a carrier or housing for supporting or containing the electronic locator circuit 136 and a coupling or securing mechanism for securing the housing or carrier to the key. The electronic locator circuit 136 can be secured to an inner or outer surface of the carrier or housing, insertion molded into the carrier or housing, or otherwise attached to the carrier. The securing mechanism can include one or more fasteners, mating snap catches, or a strapping device, such as a cable tie and the like. Alternatively, the housing or carrier can be secured to the key by friction or by providing an interference fit between the carrier and the key.

Although exemplary embodiments of the present invention have been shown and described with reference to particular embodiments and applications thereof, it will be apparent to those having ordinary skill in the art that a number of changes, modifications, or alterations to the invention as described herein may be made, none of which depart from the spirit or scope of the present invention. All such changes, modifications, and alterations should therefore be seen as being within the scope of the present invention.

Various alternatives and embodiments are contemplated as being within the scope of the following claims particularly pointing out and distinctly claiming the subject matter regarded as the invention.

We claim:

1. A system for locating a plurality of objects, the system comprising:
a transmitter unit having a plurality of object locating switches, an RF transmitter for producing a plurality of uniquely coded activation signals and a microprocessor positioned between the plurality of object locating switches and the RF transmitter for controlling the transmission of the plurality of coded RF activation signals, the microprocessor including a memory for storing a plurality of target address codes, each target address code being associated with one of the object locating switches, whereupon depression of one of the object locating switches, the RF transmitter transmits the activation signal including the target address code assigned to the object locating switch depressed; and
a plurality of remote locator units, each remote unit including an RF receiver for receiving the activation signals including the target address codes transmitted by the RF transmitter and a microprocessor coupled to the RF receiver, the microprocessor including a memory for storing a programmable target address, wherein the microprocessor activates an indicator device upon the RF receiver receiving the target address code corresponding to the stored target address.

2. The system of claim 1 wherein the activation signal including the target address codes is transmitted by the RF transmitter at a single frequency.

3. The system of claim 2 wherein the single frequency is 315 MHz.

4. The system of claim 1 wherein the indicator device generates an audible signal.

5. The system of claim 1 wherein the indicator device generates a visible signal.

6. The system of claim 1 wherein the remote locator unit is incorporated into the object to be located and cannot be separated therefrom.

7. The system of claim 6 wherein the object to be located is a piece of luggage.

8. The system of claim 6 wherein the object to be located is a power tool.

9. The system of claim 6 wherein the object to be located is a key.

10. The system of claim 1 wherein at least one of the remote locator units is secured to a medication container.

11. The system of claim 10 wherein the remote locator unit formed as a portion of the medication container.

12. The system of claim 10 wherein the remote locator unit includes a reset switch, wherein depression of the reset switch terminates the activation of the indicator device.

13. The system of claim 10 wherein the remote locator unit includes a memory storage device for storing a preseleted sound sample such that the remote locator unit can generate the sound sample upon receipt of the target address code.

14. The system of claim 1 wherein the remote locator unit includes a memory storage device for storing a preselected sound sample such that the remote locator unit can generate the sound sample upon receipt of the target address code.

15. The system of claim 5 wherein at least one of the remote locator units includes an activation switch, wherein the microprocessor activates the indicator device to generate the visible signal upon receiving the target address code for the remote locator unit or upon depression of the activation switch on the remote locator unit.

16. The system of claim 15 wherein the indicator device is activated for a predetermined period of time upon depression of the activation switch.

17. The system of claim 1 wherein the activation signal is transmitted at a single frequency and includes a data packet containing one of the plurality of the target address codes.

18. The system of claim 1 wherein the object to be located is a portable work tool powered by a removable battery pack, the system further comprising at least one adapter positioned between one of the portable tools and the associated battery pack, the adapter including one of the remote locator units.

19. The system of claim 18 wherein the adapter includes a light source.

20. The system of claim 18 wherein the light source is mounted onto a flexible neck.

21. The system of claim 18 wherein the transmitter unit further includes a master switch and the microprocessor includes a master address code associated with the master switch, wherein the RF transmitter transmits the activation signal including the master address code upon depression of the master switch; and
wherein the remote locator unit including the master address stored in the remote locator unit microprocessor, wherein the microprocessor activates the indicator upon the RF receiver receiving the master address code.

22. The system of claim 21 wherein the target address codes and the master address code are transmitted by the RF transmitter at a single frequency.

23. The system of claim 22 wherein the master address code stored in the remote locator unit for each of the plurality of adapters is the same.

24. The system of claim 18 wherein each of the adapters includes a tool socket for connection to the portable work tool and a battery socket for receiving the removable battery pack.

25. The system of claim 18 wherein the adapter is integrally formed with the removable battery pack.

26. The system of claim 18 wherein the RF receiver and microprocessor of each integrated remote locator unit receives electrical power from the removable battery pack.

27. The system of claim 19 wherein the portable work tool includes an activation trigger, wherein the light source of the adapter is activated upon depression of the trigger.

28. A system for locating a plurality of objects, the system comprising:
a transmitter unit having a plurality of switches including a plurality of object locating switches and a master switch, an RF transmitter for producing a plurality of uniquely coded activation signals, and a microprocessor positioned between the plurality of switches and the RF transmitter for controlling the transmission of the plurality of coded RF activation signals, the microprocessor including a memory for storing a plurality of target address codes and a master address code, each target address code being associated with one of the object locating switches and the master address code being associated with the master switch, whereupon depression of one of the object locating switches or the master switch, the RF transmitter transmits the activation signal including the target address code or master address code associated with the depressed switch; and
a plurality of remote locator units, each remote unit including an RF receiver for receiving the activation signals including the target address codes or the master code transmitted by the RF transmitter and a microprocessor coupled to the RF receiver, the microprocessor including a memory for storing a programmable target address and a programmable master address, wherein the microprocessor activates an indicator device upon the RF receiver receiving either the target address code corresponding to the stored target address or the master address code corresponding to the stored master address.

29. The system of claim 28 wherein the target address codes and the master address code are transmitted by the RF transmitter at a single frequency.

30. The system of claim 29 wherein the single frequency is 315 MHz.

31. The system of claim 28 wherein the indicator device is audible.

32. The system of claim 28 wherein the indicator device is visible.

33. The system of claim 28 wherein the master address code stored by each of the plurality of remote locator units is the same.

34. The system of claim 28 wherein the indicator devices on all of the remote locator units are activated upon transmission of the activation signal including the master address code.

35. The system of claim 32 wherein the remote locator unit includes an activation switch, wherein the indicator device is activated by the microprocessor upon receipt of the target address code for the remote locator unit or upon depression of the activation switch.

36. The system of claim 28 wherein the remote locator unit is incorporated into the object to be located and cannot be separated therefrom.
